(19) United States
(12) Patent Application Publication
(10) Pub. No.: US 2025/0063073 A1
(43) Pub. Date: Feb. 20, 2025

(54) METHOD AND APPARATUS FOR P-CSCF RESTORATION AND P-CSCF INFORMATION REGISTRATION

(71) Applicant: Telefonaktiebolaget LM Ericsson (publ), Stockholm (SE)

(72) Inventors: Yingjiao He, Shanghai (CN); Jesus Angel de Gregorio Rodriguez, Madrid (ES); Emiliano Merino Vazquez, Madrid (ES); Jinyin Zhu, Shanghai (CN); Fuencisla Garcia Azorero, Madrid (ES)

(21) Appl. No.: 18/725,890

(22) PCT Filed: Jan. 4, 2023
(86) PCT No.: PCT/CN2023/070365

§ 371 Date: Jul. 1, 2024

(30) Foreign Application Priority Data
Jan. 7, 2022 (WO) PCT/CN2022/070766
Jan. 17, 2022 (WO) PCT/CN2022/072357

(51) Int. Cl. H04L 65/1073; H04L 65/1045; H04W 48/16

(52) U.S. Cl. CPC H04L 65/1073; H04L 65/1045; H04W 48/16

(57) ABSTRACT

Embodiments of the present disclosure provide method and apparatus for P-CSCF restoration and P-CSCF information registration. A method performed by a session management node comprises receiving a message from a data management node or a policy control node or a first access and mobility node. The message may indicate proxy call session control function (P-CSCF) restoration and information of a failed P-CSCF. The method may further comprise receiving a profile of the failed P-CSCF from a network repository function (NRF). The profile of the failed P-CSCF may comprise address information of Mw interface of the failed P-CSCF and address information of Gm interface of the failed P-CSCF. The method further comprises deriving address information of Gm interface of the failed P-CSCF based on the information of the failed P-CSCF and the profile of the failed P-CSCF.

### TECHNICAL FIELD

The non-limiting and exemplary embodiments of the present disclosure generally relate to the technical field of communications, and specifically to methods and apparatuses for Proxy Call Session Control Function (P-CSCF) restoration and P-CSCF information registration.

### BACKGROUND

This section introduces aspects that may facilitate a better understanding of the disclosure. Accordingly, the statements of this section are to be read in this light and are not to be understood as admissions about what is in the prior art or what is not in the prior art.

According to 3rd Generation Partnership Project (3GPP) TS 23.501 V17.2.0, the disclosure of which is incorporated by reference herein in its entirety, P-CSCF selection functionality may be used by session management function (SMF) to select the P-CSCF for an Internet protocol multimedia subsystem (IMS) protocol data unit (PDU) session of a user equipment (UE). The SMF can utilize the Network Repository Function (NRF) to discover the P-CSCF instance(s). The NRF provides an IP (Internet protocol) address or a fully qualified domain name (FQDN) of P-CSCF instance(s) to the SMF. The P-CSCF selection function in the SMF selects the P-CSCF instance(s) based on the available P-CSCF instances obtained from NRF or based on the configured P-CSCF information in the SMF. If the SMF receives FQDN(s) from the NRF or is configured with FQDN(s), the SMF shall resolve these to IP addresses for sending to the UE in the PDU session response.

The following factors may be considered during the P-CSCF discovery and selection: S-NSSAI (Single Network Slice Selection Assistance Information) of the PDU Session, UE location information, Local operator policies, Availability of candidate P-CSCFs, UE IP address, Access Type, Proximity to location of selected UPF, or Selected Data Network Name (DNN).

The P-CSCF may register in the NRF by providing a profile of the P-CSCF to NRF. NRF marks the P-CSCF available.

According to 3GPP TS 29.510 V17.4.0, the disclosure of which is incorporated by reference herein in its entirety, the definition of type PcscfInfo (information of P-CSCF network function (NF) instance or the profile of the P-CSCF) is as Table 1, which is same as table 6.1.6.2.53-1 of 3GPP TS 29.510 V17.4.0.

TABLE 1
Definition of type PcscfInfo

| Attribute name | Data type | P | Cardinality | Description |
|---|---|---|---|---|
| access Type | array(Access Type) | C | 1 . . . N | If included, this IE shall contain the access type |
| | | | | (3GPP_ACCESS and/or NON_3GPP_ACCESS) |
| | | | | supported by the P-CSCF. |
| | | | | If not included, it shall be assumed that all access types |
| | | | | are supported. |
| dnnList | array(Dnn) | O | 1 . . . N | DNNs supported by the P-CSCF. The DNN shall contain |
| | | | | the Network Identifier and it may additionally contain an |
| | | | | Operator Identifier. If the Operator Identifier is not |
| | | | | included, the DNN is supported for all the PLMNs in the |
| | | | | plmnList of the NF Profile. |
| | | | | If not provided, the P-CSCF can serve any DNN. |
| gmFqdn | Fqdn | O | 0 . . . 1 | FQDN of the P-CSCF for the Gm interface |
| gmIpv4Addresses | array(Ipv4Addr) | O | 1 . . . N | IPv4 address(es) of the P-CSCF for the Gm interface |
| gmIpv6Addresses | array(Ipv6Addr) | O | 1 . . . N | IPv6 address(es) of the P-CSCF for the Gm interface |
| servedIpv4AddressRanges | array(Ipv4AddressRange) | O | 1 . . . N | List of ranges of UE IPv4 addresses used on the Gm |
| | | | | interface, served by P-CSCF. |
| | | | | The absence of this attribute does not mean the P-CSCF |
| | | | | can serve any IPv4 address. |
| servedIpv6PrefixRanges | array(Ipv6PrefixRange) | O | 1 . . . N | List of ranges of UE IPv6 prefixes used on the Gm |
| | | | | interface, served by P-CSCF. |
| | | | | The absence of this attribute does not mean the P-CSCF |
| | | | | can serve any IPv6 prefix. |

Although network elements in a network may have a high availability, some maintenance downtime and occasional failures are unavoidable. Communication links although designed with robust protocols between the network elements are also subject to failures.

For example, P-CSCF failure may be detected during an originating Session Initiation Protocol (SIP) procedure or terminating SIP procedure. When P-CSCF failure is detected, various mechanisms for P-CSCF restoration can be invoked (by e.g. session management function (SMF), unified data management (UDM) or policy control function (PCF)), depending on the mechanism utilized.

According to 3rd Generation Partnership Project (3GPP) TS 23.380 V17.0.0, the disclosure of which is incorporated by reference herein in its entirety, the P-CSCF failure detection at SMF/UPF (session management function/User plane Function) is an optional mechanism. This mechanism is executed when an originating request cannot be served due to a P-CSCF failure, as long as there are no other registration flows for an originating user equipment (UE) using an available P-CSCF. Once the P-CSCF is reported as failed, the SMF initiates Internet protocol multimedia subsystem (IMS) protocol data unit (PDU) session update procedure, so as to trigger the UE to re-select a P-CSCF and to register again to IMS.

FIG. 1 shows a flowchart of P-CSCF failure detection at SMF/UPF. FIG. 1 is same as FIG. 5.8.3.2-1 of 3GPP TS 23.380 V17.0.0.

The following description is a copy of clause 5.8.3.2 of 3GPP TS 23.380 V17.0.0.

1. The UE sends a PDU Session Establishment Request towards the AMF, to establish a PDU session for IMS service.

2. The AMF invokes Nsmf_PDUSession_CreateSMContext service operation to the SMF, to request the SMF to create PDU session for IMS service.

3. The SMF invokes Npcf_SMFPolicyControl_Get service operation to the PCF, to retrieve session related policy.

4. The SMF selects appropriate UPF for IMS service and requests the UPF to establish N4 session.

5. When PDU session is created, the SMF invokes Namf_Communication_NIN2Message Transfer service operation to the AMF, to inform the request of PDU session establishment. A list of P-CSCF address is also included in the ePCO as specified in 3GPP TS 24.008 [4], clause 10.5.6.3A.

6. The AMF sends PDU Establishment Response message to the UE, with a list of P-CSCF included in the ePCO as specified in 3GPP TS 24.008 [4], clause 10.5.6.3A.

7. The UE performs an initial registration towards a P-CSCF from the received list.

8. The P-CSCF sends Rx Push (see 3GPP TS 29.214 [7]) to provide the PCF with the P-CSCF selected by the UE. The PCF sends Rx Push response.

9. The PCF sends P-CSCF address to the SMF, e.g. using Notification procedure.

10. The P-CSCF sends 200 OK to the UE.

Upon P-CSCF failure detection by the SMF UPF;

11.a If the requirements listed at clause 5.8.2.2 are fulfilled, the SMF initiates the P-CSCF address list update procedure to trigger the P-CSCF reselection by the UE as specified in clause 5.8.2.2

11.b If the requirements listed at clause 5.8.2.3 are fulfilled, the SMF initiates the DHCP based P-CSCF selection triggering procedure to trigger the P-CSCF reselection by the UE as specified in clause 5.8.2.3.

11.c Otherwise the SMF initiates the PDU Session Release with Reactivation procedure to trigger the UE re-establish IMS PDUS session, as specified in clause 5.8.2.4.

12. Subsequent to step 11, the UE performs an initial IMS registration towards the new P-CSCF, as specified in clause 5.8.2.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

When P-CSCF failure is detected, the SMF triggers the related procedures, as specified in clause 5.8.2 of 3GPP TS 23.380 V17.0.0 for P-CSCF restoration. However periodically detecting P-CSCF on SMF is complicated and cost consuming, especially when an operator has many P-CSCFs configured in the network.

To overcome or mitigate at least one of above mentioned problems or other problems, an improved solution for P-CSCF restoration may be desirable.

In an embodiment, S-CSCF (serving CSCF) may detect that a P-CSCF is failed. The information of the failed P-CSCF (such as the IP address of Mw interface of the failed P-CSCF and/or FQDN (fully qualified domain name) of Mw interface of the failed P-CSCF and/or network function instance ID (identifer) of the failed P-CSCF) may be sent to the SMF for example via UDM or PCF. The failed P-CSCF address received by SMF is the P-CSCF Mw interface address (such as IP address), while the UE uses P-CSCF Gm interface address. The Gm interface address is different with the Mw interface address in a real IMS network deployment. The SMF needs to find a corresponding P-CSCF address of the Gm interface by a local mapping table of P-CSCF address information on Mw interface and P-CSCF address information on Gm interface.

However the local mapping table for P-CSCF address information on Mw interface and P-CSCF address information on Gm interface is not efficient and is difficult and cost for the normal maintenance.

To overcome or mitigate at least one of above mentioned problems or other problems, an improved solution for P-CSCF information registration may be desirable.

In a first aspect of the disclosure, there is provided a method performed by a session management node. The method comprises receiving a message from a data management node or a policy control node or a first access and mobility node. The message may indicate proxy call session control function (P-CSCF) restoration and information of a failed P-CSCF. The method may further comprise receiving a profile of the failed P-CSCF from a network repository function (NRF). The profile of the failed P-CSCF may comprise address information of Mw interface of the failed P-CSCF and address information of Gm interface of the failed P-CSCF. The method further comprises deriving address information of Gm interface of the failed P-CSCF based on the information of the failed P-CSCF and the profile of the failed P-CSCF. The method further comprises, for a protocol data unit (PDU) session, based on the received message, triggering a P-CSCF restoration procedure by sending a PDU session release command or a PDU session modification command to a user equipment via the first or a second access and mobility node. The PDU session modification command comprises an updated P-CSCF list based on the information of the failed P-CSCF.

In an embodiment, the failed P-CSCF is detected by a serving CSCF (S-CSCF).

In an embodiment, when the message is received from the data management node, the message is an Nudm_UECM_PCscfRestoration notification.

In an embodiment, when the message is received from the policy control node, the message is an Npcf_SMPolicyControl_UpdateNotify Request.

In an embodiment, when the message is received from the first access and mobility node, the message is an Nsmf_PDUSession_UpdateSMContext Request.

In an embodiment, the session management node comprises a session management function (SMF). The first and second access and mobility nodes comprise an access and mobility management function (AMF). The data management node comprises a unified data management (UDM). The policy control node comprises a policy control function (PCF).

In an embodiment, the information of the failed P-CSCF comprises at least one of an Internet protocol version 4 address of Mw interface of the failed P-CSCF, a network function instance identifier the failed P-CSCF, an Internet protocol version 6 address of Mw interface of the failed P-CSCF, or a fully qualified domain name of Mw interface of the failed P-CSCF.

In an embodiment, the PDU session modification command is sent to the user equipment when the user equipment supports P-CSCF re-selection.

In an embodiment, the address information of Mw interface of the failed P-CSCF comprises at least one of Internet protocol version 4 address of the failed P-CSCF for the Mw interface, Internet protocol version 6 address of the failed P-CSCF for the Mw interface, or fully qualified domain name of the failed P-CSCF for the Mw interface.

In an embodiment, the address information of Gm interface of the failed P-CSCF comprises at least one of Internet protocol version 4 address of the failed P-CSCF for the Gm interface, Internet protocol version 6 address of the failed P-CSCF for the Gm interface, or fully qualified domain name of the failed P-CSCF for the Gm interface.

In an embodiment, the method further comprises marking the failed P-CSCF as temporarily not available for a period of time. Information of the failed P-CSCF will not be sent to a user equipment when allocating a P-CSCF list for a user equipment during the period of time.

In an embodiment, the method further comprises the Gm interface defines an interface between a P-CSCF and a user equipment and the Mw interface defines an interface between a P-CSCF and other CSCF.

In a second aspect of the disclosure, there is provided a method performed by a first network repository function (NRF). The method comprises receiving a register request comprising a profile of a proxy call session control function (P-CSCF) from the P-CSCF. The profile comprises address information of the P-CSCF for an Mw interface and address information of the P-CSCF for a Gm interface. The method further comprises storing the profile of the P-CSCF. The method further comprises sending a register response to the P-CSCF.

In an embodiment, the register request is Nnrf_NFManagement_NFRegister Request and the register response is Nnrf_NFManagement_NFRegister response.

In an embodiment, the method further comprises receiving an update request comprising an updated profile of the P-CSCF from the P-CSCF. The updated profile comprises updated address information of the P-CSCF for the Mw interface and/or updated address information of the P-CSCF for the Gm interface. The method further comprises storing the updated profile of the P-CSCF. The method further comprises sending an update response to the P-CSCF.

In an embodiment, the update request is Nnrf_NFManagement_NFUpdate Request and the update response is Nnrf_NFManagement_NFUpdate response.

In an embodiment, the address information of the P-CSCF for the Mw interface comprises at least one of Internet protocol version 4 address of the P-CSCF for the Mw interface, Internet protocol version 6 address of the P-CSCF for the Mw interface, or fully qualified domain name of the P-CSCF for the Mw interface.

In an embodiment, the address information of the P-CSCF for the Gm interface comprises at least one of Internet protocol version 4 address of the P-CSCF for the Gm interface, Internet protocol version 6 address of the P-CSCF for the Gm interface, or fully qualified domain name of the P-CSCF for the Gm interface.

In an embodiment, the method further comprises receiving a request for discovering P-CSCF from a network function (NF). The method further comprises determining at least one P-CSCF matching the request. The method further comprises sending a response comprising respective profile of the at least one P-CSCF to the NF. The respective profile of the at least one P-CSCF comprises respective address information of the at least one P-CSCF for respective Mw interface and respective address information of the at least one P-CSCF for respective Gm interface.

In an embodiment, the request is Nnrf_NFDiscovery_Request and the response is Nnrf_NFDiscovery_Request Response.

In an embodiment, the NF comprises at least one of a service communication proxy (SCP), a session management function (SMF), a second NRF, a policy control function (PCF), a serving CSCF (S-CSCF), or a unified data management (UDM).

In a third aspect of the disclosure, there is provided a method performed by a proxy call session control function (P-CSCF). The method comprises sending a register request comprising a profile of the P-CSCF to a network repository function (NRF). The profile comprises address information of the P-CSCF for an Mw interface and address information of the P-CSCF for a Gm interface. The method further comprises receiving a register response from the NRF.

In an embodiment, the register request is Nnrf_NFManagement_NFRegister Request and the register response is Nnrf_NFManagement_NFRegister response.

In an embodiment, the method further comprises sending an update request comprising an updated profile of the P-CSCF to the NRF. The updated profile comprises updated address information of the P-CSCF for the Mw interface and/or updated address information of the P-CSCF for the Gm interface. The method further comprises receiving an update response from the NRF.

In an embodiment, the update request is Nnrf_NFManagement_NFUpdate Request and the update response is Nnrf_NFManagement_NFUpdate response.

In an embodiment, the address information of the P-CSCF for the Mw interface comprises at least one of Internet protocol version 4 address of the P-CSCF for the Mw interface, Internet protocol version 6 address of the P-CSCF for the Mw interface, or fully qualified domain name of the P-CSCF for the Mw interface.

In an embodiment, the address information of the P-CSCF for the Gm interface comprises at least one of Internet protocol version 4 address of the P-CSCF for the Gm interface, Internet protocol version 6 address of the P-CSCF for the Gm interface, or fully qualified domain name of the P-CSCF for the Gm interface.

In a fourth aspect of the disclosure, there is provided a method performed by a network function (NF). The method comprises receiving a discovery response message from a network repository function (NRF) indicating a NF profile information of at least one P-CSCF. The NF profile information of the at least one P-CSCF comprises respective address information of the at least one P-CSCF for respective Mw interface and respective address information of the at least one P-CSCF for respective Gm interface.

In an embodiment, the discovery response message is an Nnrf_NFDiscovery_Request Response.

In an embodiment, the method further comprises sending a request for discovering proxy call session control function (P-CSCF) to the NRF.

In an embodiment, the request is an Nnrf_NFDiscovery_Request.

In an embodiment, the method further comprises sending a subscribe request for subscribing to be notified of a newly registered or updated P-CSCF instance to the NRF. The method further comprises receiving a notification about the newly registered or updated P-CSCF instance from the NRF. The notification comprises a profile or a profile change of the newly registered or updated P-CSCF instance. The profile or the profile change of the newly registered or updated P-CSCF instance comprises address information of the newly registered or updated P-CSCF instance for Mw interface and/or address information of the newly registered or updated P-CSCF instance for Gm interface.

In an embodiment, the subscribe request is Nnrf_NFManagement_NFStatusSubscribe Request and the notification is Nnrf_NFManagement_NFStatusNotify.

In an embodiment, the NF comprises at least one of a service communication proxy (SCP), a session management function (SMF), a second NRF, a policy control function (PCF), a serving CSCF (S-CSCF), or a unified data management (UDM).

In an embodiment, address information of a P-CSCF for Mw interface comprises at least one of Internet protocol version 4 address of the P-CSCF for the Mw interface, Internet protocol version 6 address of the P-CSCF for the Mw interface, or fully qualified domain name of the P-CSCF for the Mw interface.

In an embodiment, address information of a P-CSCF for Gm interface comprises at least one of Internet protocol version 4 address of the P-CSCF for the Gm interface, Internet protocol version 6 address of the P-CSCF for the Gm interface, or fully qualified domain name of the P-CSCF for the Gm interface.

In an embodiment, when the NF is a session management node.

In an embodiment, the Gm interface defines an interface between a P-CSCF and a user equipment and the Mw interface defines an interface between a P-CSCF and other CSCF.

In a fifth aspect of the disclosure, there is provided a session management node. The session management node comprises a processor and a memory coupled to the processor. Said memory contains instructions executable by said processor. Said session management node is operative to receive a message from a data management node or a policy control node or a first access and mobility node. The message indicates proxy call session control function (P-CSCF) restoration and information of a failed P-CSCF. Said session management node is further operative to receive a profile of the failed P-CSCF from a network repository function (NRF). The profile of the failed P-CSCF comprises address information of Mw interface of the failed P-CSCF and address information of Gm interface of the failed P-CSCF. Said session management node is further operative to derive address information of Gm interface of the failed P-CSCF based on the information of the failed P-CSCF and the profile of the failed P-CSCF. Said session management node is further operative to, for a protocol data unit (PDU) session, based on the received message, trigger a P-CSCF restoration procedure by sending a PDU session release command or a PDU session modification command to a user equipment via the first or a second access and mobility node. The PDU session modification command comprises an updated P-CSCF list based on the information of the failed P-CSCF.

In a sixth aspect of the disclosure, there is provided a first network repository function (NRF). The first NRF comprises a processor and a memory coupled to the processor. Said memory contains instructions executable by said processor. Said first NRF is operative to receive a register request comprising a profile of a proxy call session control function (P-CSCF) from the P-CSCF. The profile comprises address information of the P-CSCF for an Mw interface and address information of the P-CSCF for a Gm interface. Said first NRF is further operative to store the profile of the P-CSCF. Said first NRF is further operative to send a register response to the P-CSCF.

In a seventh aspect of the disclosure, there is provided a proxy call session control function (P-CSCF). The P-CSCF comprises a processor and a memory coupled to the processor. Said memory contains instructions executable by said processor. Said P-CSCF is operative to send a register request comprising a profile of the P-CSCF to a network repository function (NRF). The profile comprises address information of the P-CSCF for an Mw interface and address information of the P-CSCF for a Gm interface. Said P-CSCF is further operative to receive a register response from the NRF.

In an eighth aspect of the disclosure, there is provided a network function (NF). The NF comprises a processor and a memory coupled to the processor. Said memory contains instructions executable by said processor. Said NF is operative to receive a discovery response message from a network repository function (NRF) indicating a NF profile information of at least one P-CSCF. The NF profile information of the at least one P-CSCF comprises respective address information of the at least one P-CSCF for respective Mw interface and respective address information of the at least one P-CSCF for respective Gm interface.

In a ninth aspect of the disclosure, there is provided a session management node. The session management node comprises a first receiving module configured to receive a message from a data management node or a policy control node or a first access and mobility node. The message may indicate proxy call session control function (P-CSCF) restoration and information of a failed P-CSCF. The session management node further comprises a second receiving module configured to receive a profile of the failed P-CSCF from a network repository function (NRF). The profile of the failed P-CSCF may comprise address information of Mw interface of the failed P-CSCF and address information of Gm interface of the failed P-CSCF. The session management node further comprises a deriving module configured to derive address information of Gm interface of the failed P-CSCF based on the information of the failed P-CSCF and the profile of the failed P-CSCF. The session management node further comprises a triggering module configured to, for a protocol data unit, PDU, session, based on the received message, trigger a P-CSCF restoration procedure by sending a PDU session release command or a PDU session modification command to a user equipment via the first or a second access and mobility node. The PDU session modification command may comprise an updated P-CSCF list based on the information of the failed P-CSCF.

In a tenth aspect of the disclosure, there is provided is a first NRF. The first NRF comprises a first receiving module configured to receive a register request comprising a profile of a proxy call session control function (P-CSCF) from the P-CSCF. The profile comprises address information of the P-CSCF for an Mw interface and address information of the P-CSCF for a Gm interface. The first NRF further comprises a first storing module configured to store the profile of the P-CSCF. The first NRF further comprises a first sending module configured to send a register response to the P-CSCF.

In an embodiment, the first NRF further comprises a second receiving module configured to receive an update request comprising an updated profile of the P-CSCF from the P-CSCF. The updated profile comprises updated address information of the P-CSCF for the Mw interface and/or updated address information of the P-CSCF for the Gm interface. The first NRF further comprises a second storing module configured to store the updated profile of the P-CSCF. The first NRF further comprises a second sending module configured to send an update response to the P-CSCF.

In an embodiment, the first NRF further comprises a third receiving module configured to receive a request for discovering P-CSCF from a network function (NF). The first NRF further comprises a determining module configured to determine at least one P-CSCF matching the request. The first NRF further comprises a third sending module configured to send a response comprising respective profile of the at least one P-CSCF to the NF. The respective profile of the at least one P-CSCF comprises respective address information of the at least one P-CSCF for respective Mw interface and respective address information of the at least one P-CSCF for respective Gm interface.

In an eleventh aspect of the disclosure, there is provided a P-CSCF. The P-CSCF comprises a first sending module configured to send a register request comprising a profile of the P-CSCF to a network repository function (NRF). The profile comprises address information of the P-CSCF for an Mw interface and address information of the P-CSCF for a Gm interface. The P-CSCF further comprises a first receiving module configured to receive a register response from the NRF.

In an embodiment, the P-CSCF further comprises a second sending module configured to send an update request comprising an update request comprising an updated profile of the P-CSCF to the NRF. The updated profile comprises updated address information of the P-CSCF for the Mw interface and/or updated address information of the P-CSCF for the Gm interface. The P-CSCF further comprises a second receiving module configured to receive an update response from the NRF.

In a twelfth aspect of the disclosure, there is provided a network function. The network function further comprises a first receiving module configured to receive a discovery response message from a network repository function (NRF) indicating a NF profile information of at least one P-CSCF. The NF profile information of the at least one P-CSCF may comprise respective address information of the at least one P-CSCF for respective Mw interface and respective address information of the at least one P-CSCF for respective Gm interface.

In an embodiment, the network function may further comprise a first sending module configured to send a request for discovering proxy call session control function (P-CSCF) to a network repository function (NRF).

In an embodiment, the network function further comprises a second sending module configured to send a subscribe request for subscribing to be notified of a newly registered or updated P-CSCF instance to the NRF. The network function further comprises a second receiving module configured to receive a notification about the newly registered or updated P-CSCF instance from the NRF. The notification comprises a profile or a profile change of the newly registered or updated P-CSCF instance. The profile or the profile change of the newly registered or updated P-CSCF instance comprises address information of the newly registered or updated P-CSCF instance for Mw interface and/or address information of the newly registered or updated P-CSCF instance for Gm interface.

In an embodiment, when the NF is a session management node, the network function further comprises a third receiving module configured to receive a message from a data management node or a policy control node or a first access and mobility node. The message indicates proxy call session control function (P-CSCF) restoration and information of a failed P-CSCF. The network function further comprises a deriving module configured to derive address information of the failed P-CSCF for Gm interface based on the information of the failed P-CSCF and the profile of the failed P-CSCF received from the NRF. The network function further comprises a triggering module configured to, for a protocol data unit (PDU) session using the failed P-CSCF, trigger a P-CSCF restoration procedure by sending a PDU session release command or a PDU session modification command to a user equipment by the first or a second access and mobility node. The PDU session modification command comprises an updated P-CSCF list without the failed P-CSCF.

In an embodiment, when the NF is a session management node, the network function further comprises a marking module configured to mark the failed P-CSCF as temporarily not available for a period of time. Information of the failed P-CSCF will not be sent to a user equipment when allocating a P-CSCF list for a user equipment during the period of time.

In a thirteenth aspect of the disclosure, there is provided a computer program product comprising instructions which when executed by at least one processor, cause the at least one processor to perform the method according to any one of the first, second, third or fourth aspects.

In a fourteenth aspect of the disclosure, there is provided a computer-readable storage medium storing instructions which when executed by at least one processor, cause the at least one processor to perform the method according to any one of the first, second, third or fourth aspects.

Embodiments herein may provide many advantages, of which a non-exhaustive list of examples follows. In some embodiments herein, it can directly use the existing failed P-CSCF information from a network function such as S-CSCF instead of SMF detecting the P-CSCF failure periodically. In some embodiments herein, it can keep the SMF simple. In some embodiments herein, it can reduce the load of SMF. In some embodiments herein, the SMF can find the corresponding failed P-CSCF address of the Gm interface by the received pcscfInfo, instead of local configured P-CSCF mapping table. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows a flowchart of P-CSCF failure detection at SMF/UPF;

FIG. 2 schematically shows a high level architecture in the fifth generation network according to an embodiment of the present disclosure;

FIG. 3 shows a flowchart of triggering P-CSCF restoration procedure via SMF according to an embodiment of the present disclosure;

FIG. 4 shows a flowchart of triggering P-CSCF restoration procedure via policy control function (PCF) according to an embodiment of the present disclosure;

FIG. 5 shows a scenario where the home subscriber server (HSS) sends a request to the UDM to initiate P-CSCF restoration according to an embodiment of the present disclosure;

FIG. 6 shows a flowchart of a method according to an embodiment of the present disclosure;

FIG. 7a shows a flowchart of a method according to another embodiment of the present disclosure;

FIG. 7b shows a flowchart of a method according to another embodiment of the present disclosure;

FIG. 7c shows a flowchart of a method according to another embodiment of the present disclosure;

FIG. 8 shows a flowchart of a method according to another embodiment of the present disclosure;

FIG. 9 shows a flowchart of a method according to another embodiment of the present disclosure;

FIG. 10 shows a flowchart of a method according to another embodiment of the present disclosure;

FIG. 11 shows a flowchart of P-CSCF restoration improvement on N10 Interface according to an embodiment of the present disclosure;

FIG. 12 shows a flowchart of P-CSCF restoration improvement on N7 Interface according to an embodiment of the present disclosure;

FIG. 13 is a block diagram showing an apparatus suitable for practicing some embodiments of the disclosure;

FIG. 14 is a block diagram showing a session management node according to an embodiment of the disclosure;

FIG. 15 is a block diagram showing a data management node according to an embodiment of the disclosure;

FIG. 16 is a block diagram showing a policy control node according to an embodiment of the disclosure;

FIG. 17 is a block diagram showing an access and mobility node according to an embodiment of the disclosure;

FIG. 18 shows a flowchart of a method according to another embodiment of the present disclosure;

FIG. 19 shows a flowchart of a method according to another embodiment of the present disclosure;

FIG. 20 shows a flowchart of a method according to another embodiment of the present disclosure;

FIG. 21 shows a flowchart of a method according to another embodiment of the present disclosure;

FIG. 22 shows a flowchart of a method according to another embodiment of the present disclosure;

FIG. 23 shows a flowchart of a method according to another embodiment of the present disclosure;

FIG. 24 shows a flowchart of a method according to another embodiment of the present disclosure;

FIG. 25 shows a flowchart of a method according to another embodiment of the present disclosure;

FIG. 26 shows a flowchart of P-CSCF restoration improvement on N10 Interface according to an embodiment of the present disclosure;

FIG. 27 shows a flowchart of P-CSCF restoration improvement on N7 Interface according to an embodiment of the present disclosure;

FIG. 28 is a block diagram showing an apparatus suitable for practicing some embodiments of the disclosure;

FIG. 29 is a block diagram showing a first NRF according to an embodiment of the disclosure;

FIG. 30 is a block diagram showing a P-CSCF according to an embodiment of the disclosure; and

FIG. 31 is a block diagram showing a network function according to an embodiment of the disclosure.

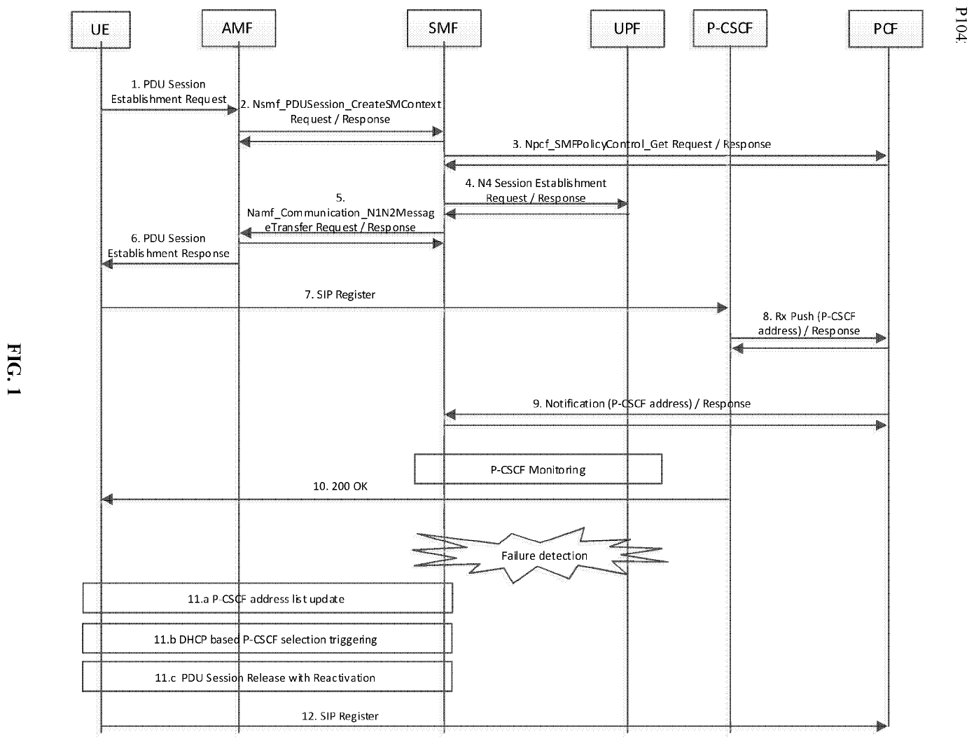

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” refers to any suitable network function (NF) which can be implemented in a network element (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP' LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

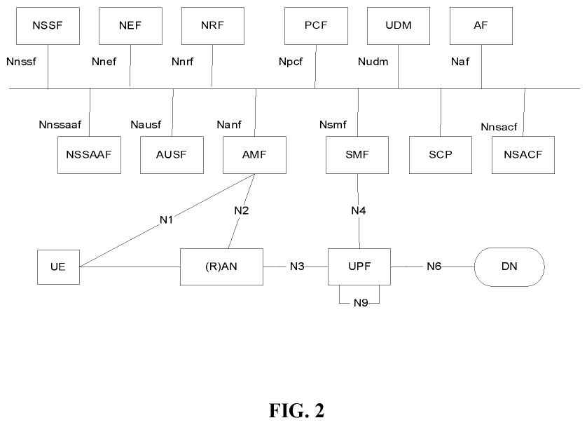

Although the subject matter described herein may be implemented in any appropriate type of system using any suitable components, the embodiments disclosed herein are described in relation to a communication system complied with the exemplary system architecture illustrated in FIG. 2. For simplicity, the system architecture of FIG. 2 only depicts some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

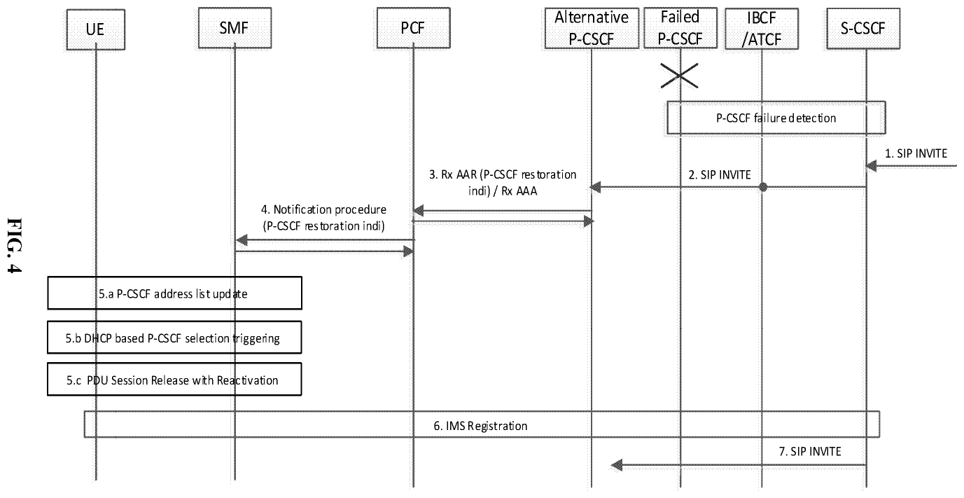

FIG. 2 schematically shows a high level architecture in the fifth generation network according to an embodiment of the present disclosure. For example, the fifth generation network may be 5GS. The architecture of FIG. 2 is same as FIG. 4.2.3-1 as described in 3GPP TS 23.501 V17.2.0, the disclosure of which is incorporated by reference herein in its entirety. The system architecture of FIG. 2 may comprise some exemplary elements such as AUSF, AMF, DN (data network), NEF, NRF, NSSF, PCF, SMF, UDM, UPF, AF, UE, (R)AN, SCP (Service Communication Proxy), NSSAAF (Network Slice-Specific Authentication and Authorization Function), NSACF (Network Slice Admission Control Function), etc.

In accordance with an exemplary embodiment, the UE can establish a signaling connection with the AMF over the reference point N1, as illustrated in FIG. 2. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 2, the exemplary system architecture also contains the service-based interfaces such as Nnrf, Nnef, Nausf, Nudm, Npcf, Namf, Nnsacf and Nsmf exhibited by NFs such as the NRF, the NEF, the AUSF, the UDM, the PCF, the AMF, the NSACF and the SMF. In addition, FIG. 2 also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 2 may be responsible for functions such as session management, mobility management, authentication, security, etc. The AUSF, AMF, DN, NEF, NRF, NSSF, PCF, SMF, UDM, UPF, AF, UE, (R)AN, SCP, NSACF may include the functionality for example as defined in clause 6.2 of 3GPP TS 23.501 V17.2.0.

Some network elements such as S-CSCF may already detect that a P-CSCF is failed and have the information of failed P-CSCF. However the information of failed P-CSCF is not sent to the session management node such as SMF in the existing P-CSCF Restoration Procedures for example as described in 3GPP TS 23.380 V17.0.0.

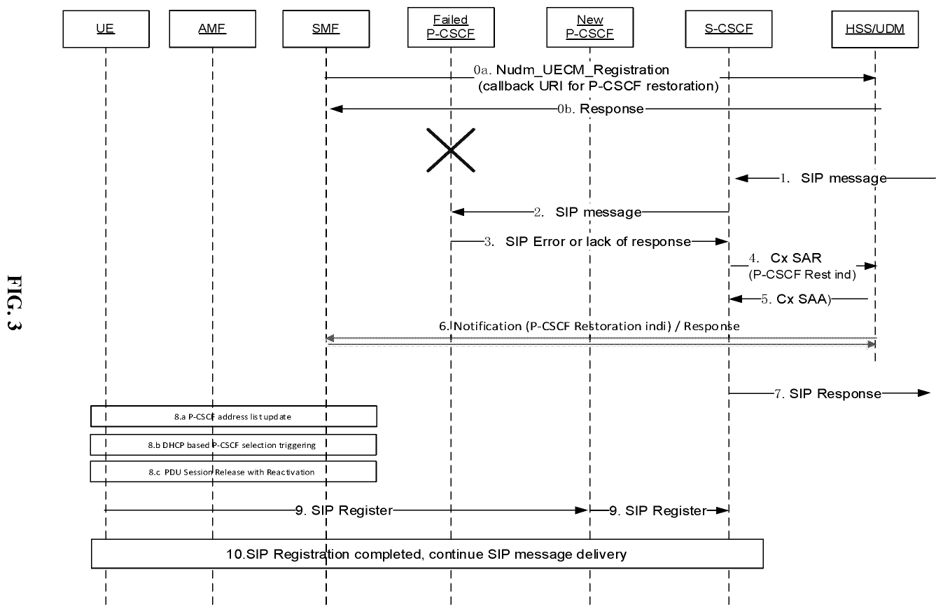

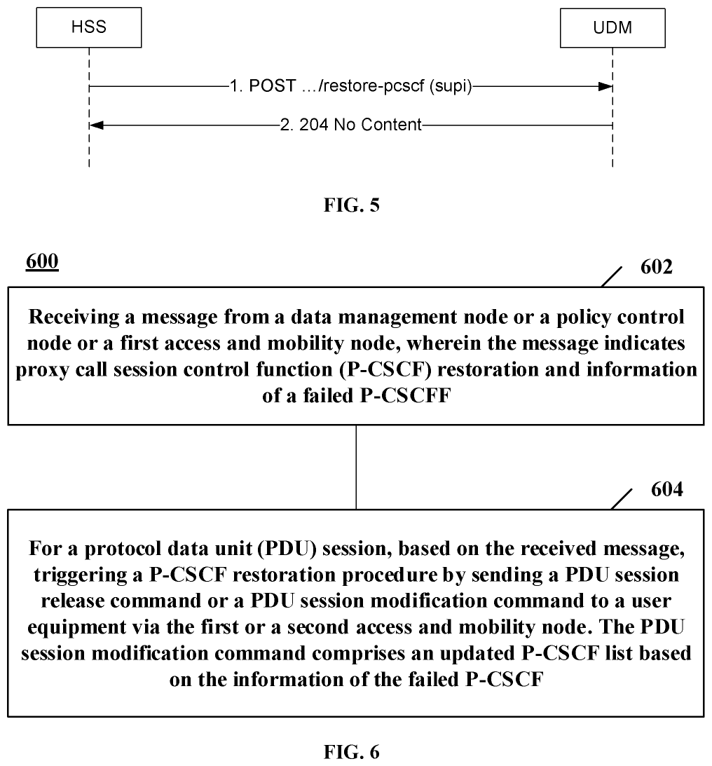

FIG. 3 shows a flowchart of triggering P-CSCF restoration procedure via SMF according to an embodiment of the present disclosure. FIG. 3 is same as FIG. 5.8.4.2-1 of 3GPP TS 23.380 V17.0.0.

The following description is a copy of clause 5.8.4.2 of 3GPP TS 23.380 V17.0.0.

During establishing PDU Session for IMS service, the SMF performs registration to the unified data management (UDM) and provides sufficient information for triggering P-CSCF restoration procedure (e.g. DNN=“IMS”, callback URI for P-CSCF restoration . . . ), as specified in 3GPP TS 29.503 V17.5.0, the disclosure of which is incorporated by reference herein in its entirety.

When the UDM determines that a P-CSCF restoration needs to be triggered, the UDM selects the SMF serving IMS, according to the SMF registration information in the UDM, to trigger the P-CSCF restoration procedure.

0: The SMF serving the IMS PDU session registers at the UDM. If the SMF supports the UDM based P-CSCF restoration mechanism, it provides a callback URI for P-CSCF restoration notifications.

1-5. The S-CSCF receives incoming SIP message. If the S-CSCF detects the previous P-CSCF is failed (e.g. due to return SIP error or lack of response), the S-CSCF sends Cx SAR message to the HSS, including P-CSCF restoration indication.

After receiving the Cx SAR message, the HSS forwards the P-CSCF restoration indication to the UDM by means of the Nudm_UECM P-CSCF-RestorationTrigger service operation (see 3GPP TS 23.632[33].

6. The UDM sends Nudm_UECM_PCscfRestoration notification to the SMF serving IMS PDU session, using the received callback URI for P-CSCF restoration notifications. The SMF accepts the Nudm message and sends HTTP response message to the UDM.

7. The S-CSCF sends a SIP response back to the originating side.

8.a If the requirements listed at clause 5.8.2.2 are fulfilled, the SMF initiates the P-CSCF address list update procedure to trigger the P-CSCF reselection by the UE as specified in clause 5.8.2.2

8.b If the requirements listed at clause 5.8.2.3 are fulfilled, the SMF initiates the DHCP based P-CSCF selection triggering procedure to trigger the P-CSCF reselection by the UE as specified in clause 5.8.2.3.

8.c Otherwise the SMF initiates the PDU Session Release with Reactivation procedure to the UE, to trigger the UE re-establish IMS PDUS session, as specified in clause 5.8.2.4.

9. Subsequent to step 8, the UE performs an initial IMS registration towards the new P-CSCF, as specified in clause 5.8.2.

10. The S-CSCF sends the suspended terminating SIP message to a newly selected P-CSCF after the successful SIP registration for the UE.

FIG. 4 shows a flowchart of triggering P-CSCF restoration procedure via policy control function (PCF) according to an embodiment of the present disclosure. FIG. 4 is same as FIG. 5.8.5.2-1 of 3GPP TS 23.380 V17.0.0.

The following description is a copy of clause 5.8.5.2 of 3GPP TS 23.380 V17.0.0.

The P-CSCF failure is detected by S-CSCF or Interconnection Border Control Functions (IBCF) Access Transfer Control Function (ATCF), as specified in clause 5.5 of 3GPP TS 23.380 V17.0.0.

1. The S-CSCF receives a terminating INVITE message.

2. As the failure of the previous P-CSCF is detected, the S-CSCF forwards the Terminating INVITE message to an alternative P-CSCF, as specified in clause 5.5. The alternative P-CSCF is chosen by local configuration.

3. The alternative P-CSCF shall send an Rx AAR message with the P-CSCF restoration indication to the associated PCF. The associated PCF is chosen as specified in 3GPP TS 23.503 [30]. The PCF shall send an Rx AAA to the P-CSCF.

4. The PCF sends P-CSCF restoration indication to the SMF serving IMS PDU session, as specified in 3GPP TS 29.512 clause 4.2.3.

5.a If the requirements listed at clause 5.8.2.2 are fulfilled, the SMF initiates the P-CSCF address list update procedure to trigger the P-CSCF reselection by the UE as specified in clause 5.8.2.2

5.b If the requirements listed at clause 5.8.2.3 are fulfilled, the SMF initiates the DHCP based P-CSCF selection triggering procedure to trigger the P-CSCF reselection by the UE as specified in clause 5.8.2.3.

5.c Otherwise the SMF initiates the PDU Session Release with Reactivation procedure to the UE, to trigger the UE re-establish IMS PDUS session, as specified in 5.8.2.4.

6. Subsequent to step 8, the UE performs an initial IMS registration towards the new P-CSCF, as specified in clause 5.8.2.

7. The S-CSCF sends the suspended terminating SIP message to a newly selected P-CSCF after the successful SIP registration for the UE.

According to 3GPP TS 29.503 V17.5.0, the definition of type PcscfRestorationNotification is as Table 1, which is same as Table 6.2.6.2.9-1 of 3GPP TS 29.503 V17.5.0.

TABLE 1
Definition of type PcscfRestorationNotification

| Attribute name | Data type | P | Cardinality | Description |
|---|---|---|---|---|
| supi | Supi | M | 1 | A SUPI that is served |
| | | | | by the failed P-CSCF |

As can be seen from Table 1, PcscfRestorationNotification does not comprise information of a failed P-CSCF. Therefore periodically detecting P-CSCF may be performed on SMF, which is complicated and cost consuming, especially when an operator has many P-CSCFs configured in the network.

FIG. 5 shows a scenario where the home subscriber server (HSS) sends a request to the UDM to initiate P-CSCF restoration according to an embodiment of the present disclosure. FIG. 5 is same as FIG. 5.3.2.8.2-1 of 3GPP TS 29.503 V17.5.0.

At step 1. The HSS sends a POST request (custom method: restore-pcscf) to the UDM. The which shall be a request contains the UE's identity Subscription Permanent Identifier (SUPI).

At step 2. The UDM responds with “204 No Content”.

On failure, the appropriate Hypertext Transfer Protocol (HTTP) status code indicating the error shall be returned and appropriate additional error information should be returned in the POST response body.

According to 3GPP TS 29.503 V17.5.0, the definition of type TriggerRequest is as Table 2, which is same as Table 6.2.6.2.12-1 of 3GPP TS 29.503 V17.5.0.

TABLE 2
Definition of type TriggerRequest

| | | | | |
|---|---|---|---|---|
| Attribute name | Data type | P | Cardinality | Description |

| | | | |
|---|---|---|---|
| supi | Supi | M | 1 |

As can be seen from Table 2, TriggerRequest does not comprise information of a failed P-CSCF. Therefore periodically detecting P-CSCF may be performed on SMF, which is complicated and cost consuming, especially when an operator has many P-CSCFs configured in the network.

According to 3GPP TS 29.512 V17.5.0, the disclosure of which is incorporated by reference herein in its entirety, a part of the definition of type SmPolicyDecision is as Table 3, which is same as Table 5.6.2.4-1 of 3GPP TS 29.512 V17.5.0.

TABLE 3
Definition of type SmPolicyDecision

| | Data | | Cardi- | | |
|---|---|---|---|---|---|
| Attribute name | type | P | nality | Description | Applicability |
| pcscfRestIndication | boolean | O | 0 . . . 1 | If this attribute is included and set to true, | PCSCF- |
| | | | | it indicates that P-CSCF Restoration is | Restoration- |
| | | | | requested. The default value “FALSE” | Enhancement |
| | | | | applies if the attribute is not present and | |
| | | | | has not been supplied previously. | |

As can be seen from Table 3, when pcscfRestIndication is included and set to true, it indicates that P-CSCF Restoration is requested. However, SmPolicyDecision does not comprise information of a failed P-CSCF. Therefore periodically detecting P-CSCF may be performed on SMF, which is complicated and cost consuming, especially when an operator has many P-CSCFs configured in the network.

Another observation is that the S-CSCF already has the information of failed P-CSCF, however the information of failed P-CSCF is not sent to the SMF or AMF or UDM.

To overcome or mitigate at least one of above mentioned problems or other problems. The embodiments of the present disclosure propose some enhancements on N10 and N7 interfaces.

In an embodiment, when S-CSCF detects that a P-CSCF is failed, the S-CSCF informs HSS/UDM with a P-CSCF restoration indicator and information of the failed P-CSCF. The UDM will trigger a P-CSCF restoration procedure. The UDM sends a P-CSCF restoration notification request with a new attribute failedPcscfOfMw (such as the IP address of Mw interface of the failed P-CSCF and/or FQDN (fully qualified domain name) of the failed P-CSCF and/or network function instance ID (identifer) of the failed P-CSCF) to the SMF and/or AMF.

In an embodiment, when S-CSCF detects that a P-CSCF is failed, the S-CSCF informs an alternative P-CSCF with a P-CSCF restoration indicator and information of the failed P-CSCF. The alternative P-CSCF then informs the PCF. The PCF will trigger a P-CSCF restoration procedure. The PCF sends Npcf_SMPolicyControl_UpdateNotify Request (SmPolicyDecsion\cscfRestIndication and a new attribute failedPcscfOfMw (such as the IP address of Mw interface of the failed P-CSCF and/or FQDN of the failed P-CSCF and/or network function instance ID of the failed P-CSCF) to the SMF.

In an embodiment, the SMF will find the corresponding P-CSCF address information on Gm interface of the failed P-CSCF by a local mapping table of P-CSCF address information on Mw interface and P-CSCF address information on Gm interface. Then the SMF can directly know the failed P-CSCF address information and need not do the periodical detection, the SMF can send Network triggered PDU session modification procedure to include the available P-CSCF list without the failed P-CSCF.

FIG. 6 shows a flowchart of a method according to an embodiment of the present disclosure, which may be performed by an apparatus implemented in or at or as a session management node or communicatively coupled to the session management node. As such, the apparatus may provide means or modules for accomplishing various parts of the method 600 as well as means or modules for accomplishing other processes in conjunction with other components.

At block 602, the session management node may receive a message from a data management node or a policy control node or a first access and mobility node. The message may comprise proxy call session control function (P-CSCF) restoration indication and information of a failed P-CSCF, that is, the message may indicate proxy call session control function (P-CSCF) restoration and information of a failed P-CSCF.

The session management node may be any suitable network node which can provide session management function. In an embodiment, the session management node may comprise a session management function (SMF).

The data management node may be any suitable network node which can provide data management function. In an embodiment, the data management node may comprise a unified data management (UDM).

The first access and mobility node may be any suitable network node which can provide access and mobility management function. In an embodiment, the first access and mobility node may comprise access and mobility management function (AMF).

The policy control node may be any suitable network node which can provide policy control function. In an embodiment, the policy control node may comprise policy control function (PCF).

The P-CSCF may provide the similar role as described in clause 4.6.1 of 3GPP TS 23.228 V17.3.0. In an embodiment, the P-CSCF may comprise Proxy-CSCF as described in clause 4.6.1 of 3GPP TS 23.228 V17.3.0.

The message may be any suitable message which can be sent from the data management node or the policy control node or the first access and mobility node to the session management node. For example, the message may be an existing message or a new message.

In an embodiment, when the message is received from the data management node, the message is Nudm_UECM_PCscfRestoration notification as described in 3GPP TS 23.380 V17.0.0.

In an embodiment, when the message is received from the policy control node, the message is Npcf_SMPolicyControl_UpdateNotify Request as described in 3GPP TS 23.502 V17.2.1.

In an embodiment, when the message is received from the first access and mobility node, the message is an Nsmf_PDUSession_UpdateSMContext Request as described in 3GPP TS 23.502 V17.2.1.

The P-CSCF restoration indication may take any suitable form such as bit, flag, indication, etc. In an embodiment, the P-CSCF restoration indication may be same as the P-CSCF restoration indication as described in 3GPP TS 23.380 V17.0.0.

The information of a failed P-CSCF may comprise any suitable information which can be used by the session management node to identify the failed P-CSCF. For example, the information of the failed P-CSCF may be the identity of the failed P-CSCF, such as NF instance identifier of the failed P-CSCF. The information of the failed P-CSCF may be the address information of the failed P-CSCF, such as Internet protocol version 4 address, Internet protocol version 6 address, fully qualified domain name, etc.

In an embodiment, the information of the failed P-CSCF comprises at least one of an Internet protocol version 4 address of Mw interface of the failed P-CSCF, a network function instance identifier the failed P-CSCF, an Internet protocol version 6 address of Mw interface of the failed P-CSCF, or a fully qualified domain name (FQDN) of Mw interface of the failed P-CSCF. According to 3GPP TS 23.228 V17.3.0, Mw is a reference point (or interface) between a CSCF and another CSCF.

In an embodiment, the information of the failed P-CSCF may comprise address information of Gm interface of the failed P-CSCF. According to 3GPP TS 23.228 V17.3.0, Gm is a reference point (or interface) between a UE and a P-CSCF. For example, when the failed P-CSCF is detected by a serving CSCF (S-CSCF), the S-CSCF may obtain the IP address or FQDN of Mw interface of the failed P-CSCF or NF ID of the failed P-CSCF, and then the S-CSCF may derive address information of Gm interface of the failed P-CSCF from the information of the failed P-CSCF (e.g., based on local mapping).

The failed P-CSCF is detected in various ways. For example, when P-CSCF failure occurs, the data management node or the policy control node or the first access and mobility node may detect it or be informed of the event by another NF (e.g. AMF, UDM, S-CSCF, etc.).

In an embodiment, the failed P-CSCF is detected by a serving CSCF (S-CSCF). The S-CSCF may be any suitable network node which can provide the similar role as described in clause 4.6.3 of 3GPP TS 23.228 V17.3.0. In an embodiment, the CSCF may comprise Serving-CSCF as described in clause 4.6.3 of 3GPP TS 23.228 V17.3.0. P-CSCF failure may be detected during an originating SIP procedure or terminating SIP procedure or based on any suitable approaches such as keep-alive mechanisms. For example, the S-CSCF may detect that the P-CSCF is failed as shown in FIGS. 2-3. In other embodiments, the S-CSCF may detect that the P-CSCF is failed based on any suitable approaches such as keep-alive mechanisms or expiry of timers.

At block 604, for a protocol data unit (PDU) session, based on the received message, the session management node triggers a P-CSCF restoration procedure by sending a PDU session release command or a PDU session modification command to a user equipment via the first or a second access and mobility node. The PDU session modification command comprises an updated P-CSCF list based on the information of the failed P-CSCF. That is, for a protocol data unit (PDU) session using the failed P-CSCF, the session management node triggers a P-CSCF restoration procedure by sending a PDU session release command or a PDU session modification command to a user equipment by the first or a second access and mobility node. The PDU session modification command comprises an updated P-CSCF list based on the information of the failed P-CSCF. The updated P-CSCF list may not include the failed P-CSCF.

In an embodiment, the P-CSCF restoration procedure may be similar to the P-CSCF Restoration for 5GC (5G core network) as described in 3GPP TS 23.380 V17.0.0. For example, at least one of P-CSCF Address List Update Procedure as described in 5.8.2.2 of 3GPP TS 23.380 V17.0.0, PDU Session Release with Reactivation Procedure as described in 5.8.2.4 of 3GPP TS 23.380 V17.0.0, Trigger P-CSCF Restoration Procedure via SMF as described in 5.8.4.2 of 3GPP TS 23.380 V17.0.0, Trigger P-CSCF Restoration Procedure via AMF as described in 5.8.4.3 of 3GPP TS 23.380 V17.0.0, etc. may be performed at block 604.

The second access and mobility node may be any suitable network node which can provide access and mobility management function. In an embodiment, the second access and mobility node may comprise access and mobility management function (AMF).

In an embodiment, the PDU session modification command may be similar to the PDU session modification command as described in 3GPP TS 23.502 V17.2.1.

In an embodiment, the PDU session release command may be similar to the PDU Session Release Command as described in 3GPP TS 23.502 V17.2.1.

In an embodiment, as described in clause 5.8.2.2 of 3GPP TS 23.380 V17.0.0, the SMF sends Namf_Communication_NIN2MessageTransfer Request (PDU Session Modification Command, list of P-CSCF address) to AMF. Within the Request, the SMF includes a new list of P-CSCF addresses without the failed P-CSCF. The AMF triggers the PDU Session Modification procedure with the UE to deliver the new list of P-CSCF without the failed P-CSCF. Upon receiving the new list of P-CSCFs without the failed P-CSCF, the UE selects a P-CSCF from the list to perform an initial SIP registration.

In an embodiment, the PDU session modification command is sent to the user equipment when the user equipment supports P-CSCF re-selection. For example, the UE may indicate the “P-CSCF Re-selection support” in the ePCO (Extended Protocol Configuration Options) IE (information element), as specified in clause 10.5.6.3A of 3GPP TS 24.008 V17.5.0, the disclosure of which is incorporated by reference herein in its entirety.

In an embodiment, there may be two or more PDU sessions using the failed P-CSCF (or selecting the failed P-CSCF to perform an initial SIP registration before the P-CSCF is detected as failed). In this case, block 604 may be performed for each PDU session using the failed P-CSCF.

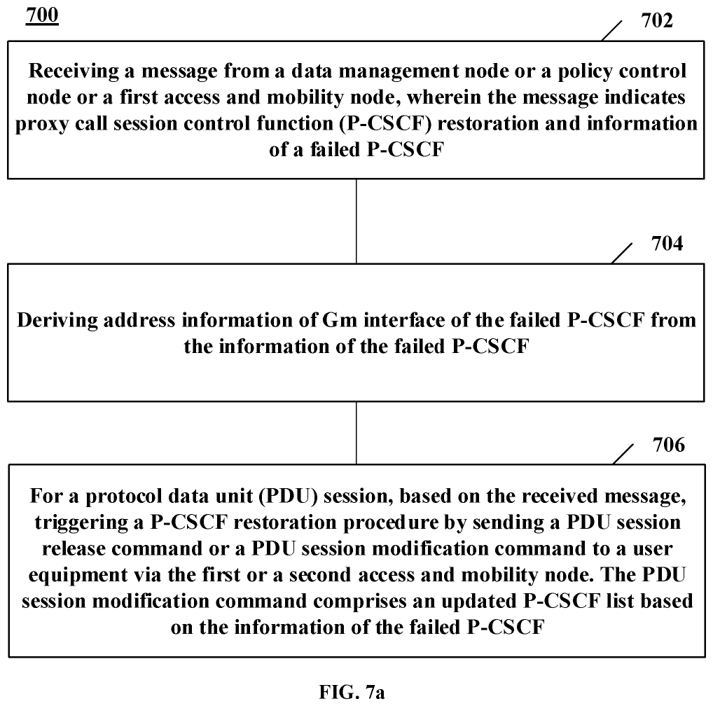

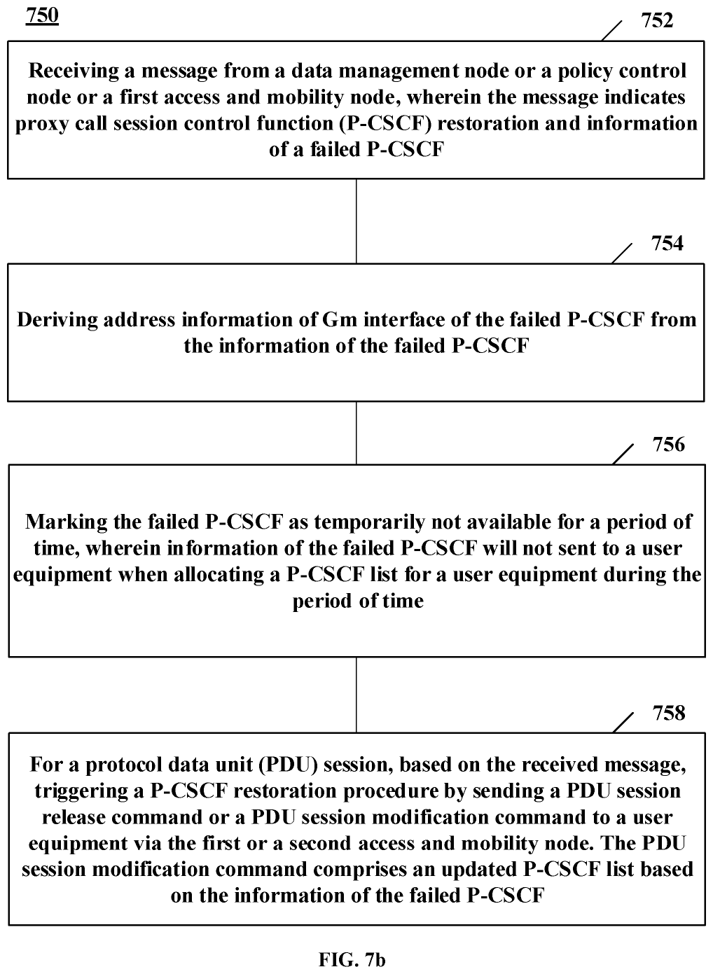

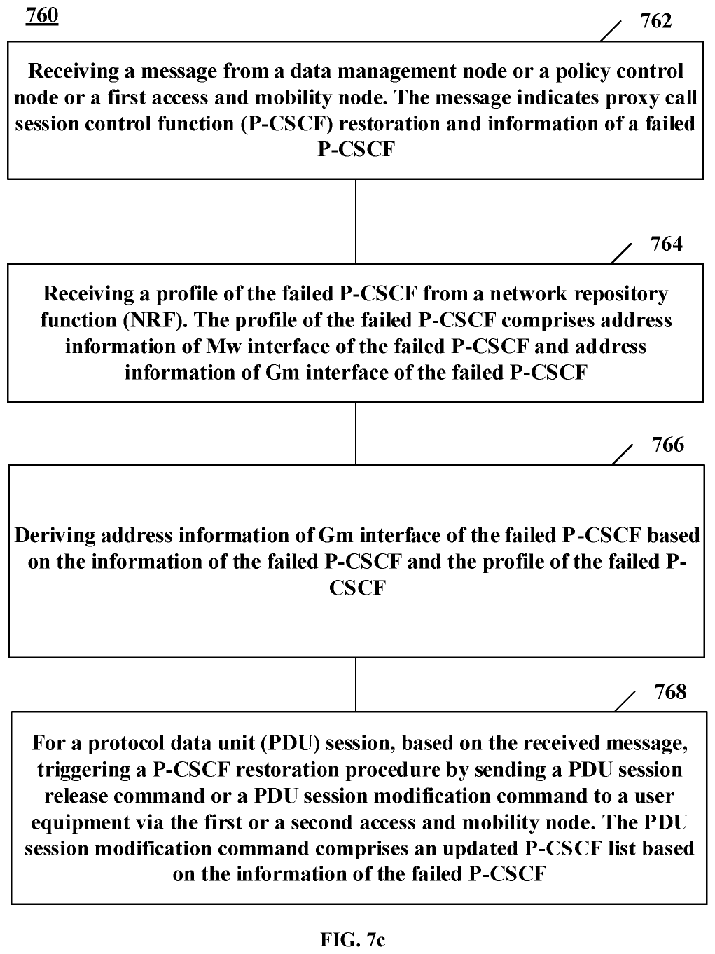

FIG. 7a shows a flowchart of a method according to another embodiment of the present disclosure, which may be performed by an apparatus implemented in or at or as a session management node or communicatively coupled to the session management node. As such, the apparatus may provide means or modules for accomplishing various parts of the method 700 as well as means or modules for accomplishing other processes in conjunction with other components. For some parts which have been described in the above embodiments, the description thereof is omitted here for brevity.

At block 702, the session management node may receive a message from a data management node or a policy control node or a first access and mobility node. The message indicates proxy call session control function (P-CSCF) restoration and information of a failed P-CSCF. Block 702 is same as block 602 of FIG. 6.

At block 704, the session management node may derive address information of Gm interface of the failed P-CSCF from the information of the failed P-CSCF.

For example, for UDM Based P-CSCF Restoration, the address of the failed P-CSCF received by SMF from UDM corresponds to the Mw interface of the P-CSCF and the (updated) address list of P-CSCFs that the SMF sends to the UE over PCO (Protocol Configuration Options) corresponds to the Gm interface of the P-CSCF. The SMF derives the Gm IP address of the failed P-CSCF from the received Mw address (FQDN and/or IP address) (e.g., based on local mapping).

For example, for PCF Based P-CSCF Restoration, the address of the failed P-CSCF received by SMF from PCF corresponds to the Mw interface of the P-CSCF and the (updated) address list of P-CSCFs that the SMF sends to the UE over PCO corresponds to the Gm interface of the P-CSCF. The SMF derives the Gm IP address of the failed P-CSCF from the received Mw address (FQDN and/or IP address) (e.g., based on local mapping).

In an embodiment, when the information of the failed P-CSCF is the address information of Gm interface of the failed P-CSCF, block 704 may be removed.

In an embodiment, the SMF may receive a profile of the failed P-CSCF from a network repository function (NRF). The profile of the failed P-CSCF comprises address information of Mw interface of the failed P-CSCF and address information of Gm interface of the failed P-CSCF. Then the SMF may derive address information of Gm interface of the failed P-CSCF based on the information of the failed P-CSCF and the profile of the failed P-CSCF.

For example, when P-CSCF registers to the NRF, the P-SCSF includes pcscfInfo with at least one of the following Mw interface information: FQDN of the P-CSCF for the Mw interface, IPv4 address(es) of the P-CSCF for the Mw interface, IPV6 address(es) of the P-CSCF for the Mw interface. The SMF can get the pcscfInfo with these new parameters by NRF discovery for P-CSCF. The SMF will find the corresponding failed P-CSCF address of the Gm interface by the received pcscfInfo.

In an embodiment, the address information of Mw interface of the failed P-CSCF comprises at least one of Internet protocol version 4 address of the failed P-CSCF for the Mw interface, Internet protocol version 6 address of the failed P-CSCF for the Mw interface, or fully qualified domain name of the failed P-CSCF for the Mw interface.

In an embodiment, the address information of Gm interface of the failed P-CSCF comprises at least one of Internet protocol version 4 address of the failed P-CSCF for the Gm interface, Internet protocol version 6 address of the failed P-CSCF for the Gm interface, or fully qualified domain name of the failed P-CSCF for the Gm interface.

At block 706, for a protocol data unit (PDU) session, based on the received message, the session management node triggers a P-CSCF restoration procedure by sending a PDU session release command or a PDU session modification command to a user equipment by the first or a second access and mobility node. The PDU session modification command comprises an updated P-CSCF list based on the information of the failed P-CSCF. Block 706 is same as block 604 of FIG. 6.

FIG. 7b shows a flowchart of a method according to another embodiment of the present disclosure, which may be performed by an apparatus implemented in or at or as a session management node or communicatively coupled to the session management node. As such, the apparatus may provide means or modules for accomplishing various parts of the method 750 as well as means or modules for accomplishing other processes in conjunction with other components. For some parts which have been described in the above embodiments, the description thereof is omitted here for brevity.

At block 752, the session management node may receive a message from a data management node or a policy control node or a first access and mobility node. The message indicates proxy call session control function (P-CSCF) restoration and information of a failed P-CSCF. Block 752 is same as block 702 of FIG. 7a.

At block 754, the session management node may derive address information of Gm interface of the failed P-CSCF from the information of the failed P-CSCF. Block 752 is same as block 704 of FIG. 7a.

At block 756, the session management node may mark the failed P-CSCF as temporarily not available for a period of time. Information of the failed P-CSCF will not be sent to a user equipment when allocating a P-CSCF list for a user equipment during the period of time. The period of time may be configured in various ways and the present disclosure has no limit on it. For example, the period of time may be configured by the operator.

At block 758, for a protocol data unit (PDU) session, based on the received message, the session management node triggers a P-CSCF restoration procedure by sending a PDU session release command or a PDU session modification command to a user equipment via the first or a second access and mobility node. The PDU session modification command comprises an updated P-CSCF list based on the information of the failed P-CSCF. Block 758 is same as block 706 of FIG. 7a.

FIG. 7c shows a flowchart of a method according to another embodiment of the present disclosure, which may be performed by an apparatus implemented in or at or as a session management node or communicatively coupled to the session management node. As such, the apparatus may provide means or modules for accomplishing various parts of the method 760 as well as means or modules for accomplishing other processes in conjunction with other components. For some parts which have been described in the above embodiments, the description thereof is omitted here for brevity.

At block 762, the session management node may receive a message from a data management node or a policy control node or a first access and mobility node. The message indicates proxy call session control function (P-CSCF) restoration and information of a failed P-CSCF.

At block 764, the session management node may receive a profile of the failed P-CSCF from a network repository function (NRF). The profile of the failed P-CSCF comprises address information of Mw interface of the failed P-CSCF and address information of Gm interface of the failed P-CSCF.

At block 766, the session management node may derive address information of Gm interface of the failed P-CSCF based on the information of the failed P-CSCF and the profile of the failed P-CSCF.

At block 768, for a protocol data unit (PDU) session, the session management node may, based on the received message, trigger a P-CSCF restoration procedure by sending a PDU session release command or a PDU session modification command to a user equipment via the first or a second access and mobility node

In an embodiment, the PDU session modification command comprises an updated P-CSCF list based on the information of the failed P-CSCF.

In an embodiment, the Gm interface defines an interface between a P-CSCF and a user equipment and the Mw interface defines an interface between a P-CSCF and other CSCF.

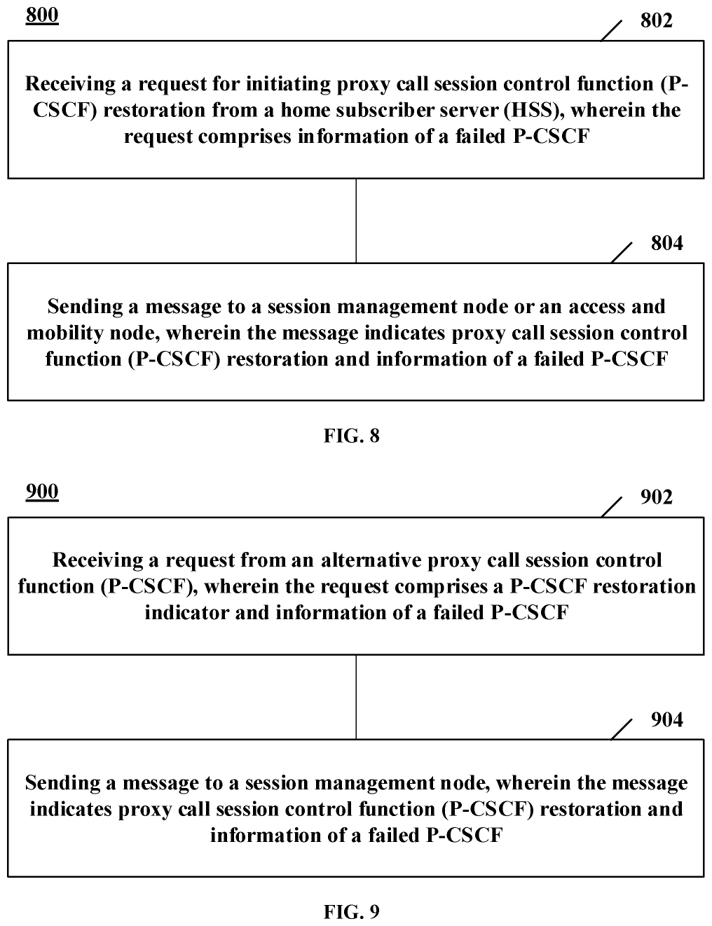

FIG. 8 shows a flowchart of a method according to another embodiment of the present disclosure, which may be performed by an apparatus implemented in or at or as a data management node or communicatively coupled to the data management node. As such, the apparatus may provide means or modules for accomplishing various parts of the method 800 as well as means or modules for accomplishing other processes in conjunction with other components. For some parts which have been described in the above embodiments, the description thereof is omitted here for brevity.

At block 802, the data management node may receive a request for initiating proxy call session control function (P-CSCF) restoration from a home subscriber server (HSS). The request comprises information of a failed P-CSCF.

In an embodiment, the request may contain the UE's identity which shall be a Subscription Permanent Identifier (SUPI).

In an embodiment, the request is a Hypertext Transfer Protocol (HTTP) POST request. For example, the request may be the POST request (custom method: restore-pcscf) as described in 3GPP TS 29.503 V17.5.0 except that it further comprises information of a failed P-CSCF.

In an embodiment, the failed P-CSCF is detected by a serving CSCF (S-CSCF).

In an embodiment, the information of the failed P-CSCF comprises at least one of an Internet protocol version 4 address of Mw interface of the failed P-CSCF, a network function instance identifier the failed P-CSCF, an Internet protocol version 6 address of Mw interface of the failed P-CSCF, or a fully qualified domain name of Mw interface of the failed P-CSCF.

At block 804, the data management node may send a message to a session management node or an access and mobility node. The message indicates proxy call session control function (P-CSCF) restoration and information of a failed P-CSCF.

In an embodiment, the message is Nudm_UECM_PCscfRestoration notification.

In an embodiment, the session management node comprises a session management function (SMF). The access and mobility node comprises an access and mobility management function (AMF). The data management node comprises a unified data management (UDM).

FIG. 9 shows a flowchart of a method according to another embodiment of the present disclosure, which may be performed by an apparatus implemented in or at or as a policy control node or communicatively coupled to the policy control node. As such, the apparatus may provide means or modules for accomplishing various parts of the method 900 as well as means or modules for accomplishing other processes in conjunction with other components. For some parts which have been described in the above embodiments, the description thereof is omitted here for brevity.

At block 902, the policy control node may receive a request from an alternative proxy call session control function (P-CSCF). The request comprises a P-CSCF restoration indicator and information of a failed P-CSCF.

In an embodiment, the alternative P-CSCF may be alternative P-CSCF as described in clause 5.8.5.2 of 3GPP TS 23.380 V17.0.0.

In an embodiment, the request is an Authorization-Authentication Request (AAR) or an Npcf_PolicyAuthorization_Create request. For example, the request may be the Rx AAR message as described in clause 5.8.5.2 of 3GPP TS 23.380 V17.0.0 except that it further comprises information of a failed P-CSCF. Rx is a reference point defined between the Policy and Charging Rules Function (PCRF) and the application function (AF) as described in 3GPP TS 29.214 V17.2.0. The Npcf_PolicyAuthorization_Create request may be the corresponding message as described in 3GPP TS 23.502 V17.2.1 except that it further comprises information of a failed P-CSCF.

In an embodiment, the failed P-CSCF is detected by a serving CSCF (S-CSCF).

In an embodiment, the information of the failed P-CSCF comprises at least one of an Internet protocol version 4 address of Mw interface of the failed P-CSCF, a network function instance identifier the failed P-CSCF, an Internet protocol version 6 address of Mw interface of the failed P-CSCF, or a fully qualified domain name of Mw interface of the failed P-CSCF.

For example, the S-CSCF receives a terminating SIP message. As the failure of the previous P-CSCF is detected by the S-CSCF, the S-CSCF forwards the SIP message with the information of the failed P-CSCF to an alternative P-CSCF. The alternative P-CSCF is chosen by local configuration. The alternative P-CSCF shall send an Rx AAR message with the P-CSCF restoration indication and information of the failed P-CSCF to the associated PCF. The PCF shall send an Rx AAA to the alternative P-CSCF.

At block 904, the policy control node may send a message to a session management node. The message indicates proxy call session control function (P-CSCF) restoration and information of a failed P-CSCF.

In an embodiment, the message is Npcf_SMPolicyControl_UpdateNotify Request.

In an embodiment, the session management node comprises session management function (SMF). The policy control node comprises policy control function (PCF).

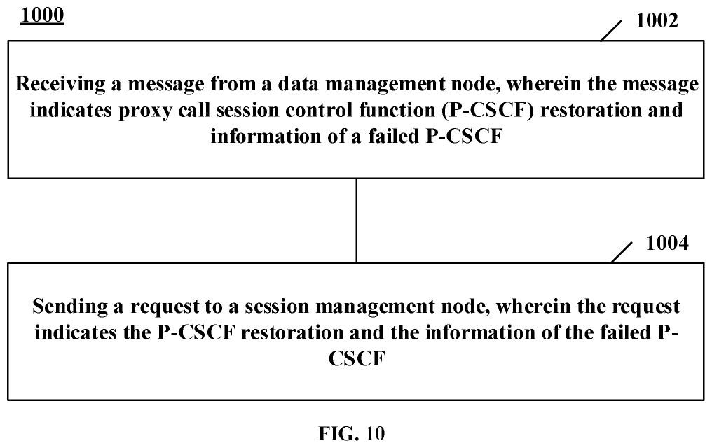

FIG. 10 shows a flowchart of a method according to another embodiment of the present disclosure, which may be performed by an apparatus implemented in or at or as an access and mobility node or communicatively coupled to the access and mobility node. As such, the apparatus may provide means or modules for accomplishing various parts of the method 1000 as well as means or modules for accomplishing other processes in conjunction with other components. For some parts which have been described in the above embodiments, the description thereof is omitted here for brevity.

At block 1002, the access and mobility node may receive a message from a data management node. The message indicates proxy call session control function (P-CSCF) restoration and information of a failed P-CSCF.

For example, the data management node may send the message to the access and mobility node at block 804 of FIG. 8, and then the access and mobility node may receive the message from the data management node.

In an embodiment, the failed P-CSCF is detected by a serving CSCF (S-CSCF).

In an embodiment, the message is Nudm_UECM_PCscfRestoration notification.

In an embodiment, the information of the failed P-CSCF comprises at least one of an Internet protocol version 4 address of Mw interface of the failed P-CSCF, a network function instance identifier the failed P-CSCF, an Internet protocol version 6 address of Mw interface of the failed P-CSCF, or a fully qualified domain name of Mw interface of the failed P-CSCF.

At block 1004, the access and mobility node may send a request to a session management node. The request indicates the P-CSCF restoration and the information of the failed P-CSCF.

In an embodiment, the request is an Nsmf_PDUSession_UpdateSMContext Request as described in 3GPP TS 23.502 V17.2.1.

In another embodiment, the access and mobility node may initiate a network-triggered PDU Session Release procedure of the IMS PDU session with Reactivation indication as specified in clause 5.8.2.4 of 3GPP TS 23.380 V17.0.0.

In an embodiment, the access and mobility node comprises an access and mobility management function (AMF), the data management node comprises a unified data management (UDM), and the session management node comprises a session management function (SMF).

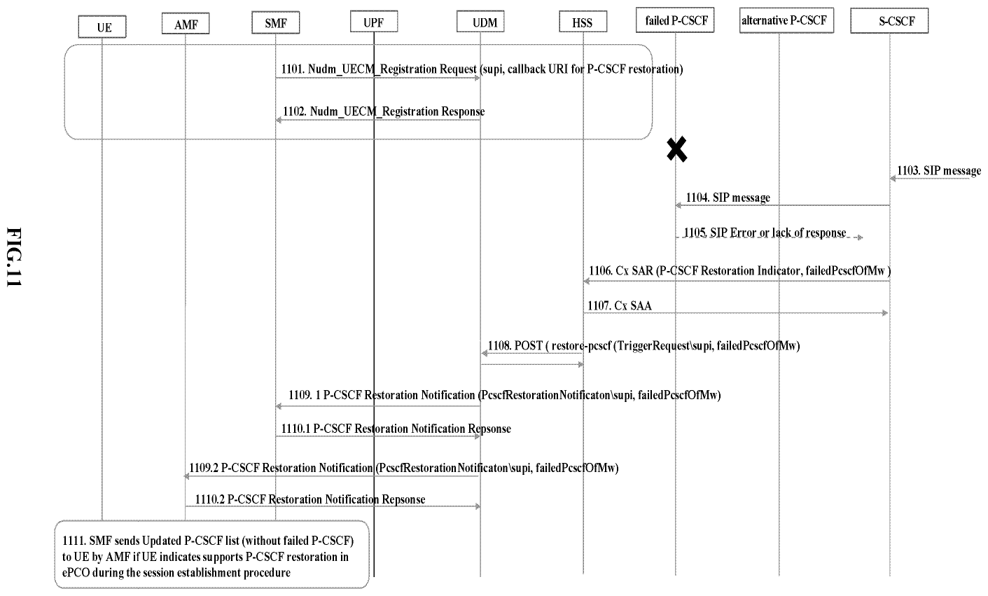

FIG. 11 shows a flowchart of P-CSCF restoration improvement on N10 Interface according to an embodiment of the present disclosure.

N10 is a reference point between the UDM and the SMF.

When S-CSCF detects that a P-CSCF is failed, the S-CSCF informs HSS/UDM with P-CSCF restoration indicator and the failed P-CSCF information. The UDM will trigger P-CSCF restoration procedure. The UDM sends P-CSCF restoration notification request with a new attribute failedPcscfOfMw (the failed P-CSCF IP address/FQDN/Instance Id) to the SMF/AMF.

At step 1101, during PDU session establishment procedure, the SMF sends Nudm_UECM_Registration Request (SUPI, callback URI (Uniform Resource Identifier) for P-CSCF restoration) to the UDM.

At step 1102, the UDM sends Nudm_UECM_Registration Response to the SMF.

At step 1103, a P-CSCF has failed. The S-CSCF receives a SIP message.

At step 1104, the S-CSCF forwards the received SIP message to the failed P-CSCF.

At step 1105, the S-CSCF doesn't receive the response from the failed P-CSCF or receives SIP error information from the failed P-CSCF.

At step 1106, the S-CSCF sends Cx SAR (Server Assignment Request) with P-CSCF

Restoration Indicator and failedPcscfOfMw) to the HSS. Cx is a reference point between a CSCF and an HSS as described in 3GPP TS 23.228 V17.3.0.

At step 1107, the HSS sends Cx SAA (Server-Assignment-Answer) to the S-CSCF.

At step 1108, the HSS sends POST (restore-pcscf (TriggerRequest\supi, failedPcscfOfMw) to the UDM. The UDM sends the response to HSS.

At step 1109.1, the UDM sends P-CSCF Restoration Notification (PcscfRestorationNotificaton\supi, failedPcscfOfMw) to the SMF.

At step 1110.1, the SMF sends P-CSCF Restoration Notification Response to the UDM.

At step 1109.2, the UDM sends P-CSCF Restoration Notification (PcscfRestorationNotificaton\supi, failedPcscfOfMw) to the AMF.

At step 1110.2, the AMF sends P-CSCF Restoration Notification Response to the UDM.

At step 1111, the SMF will find the corresponding P-CSCF address of the Gm interface. In an embodiment, the SMF will find the corresponding P-CSCF address of the Gm interface by local mapping table of P-CSCF address information on Mw interface and P-CSCF address information on Gm interface. In another embodiment, the SMF may receive a profile of the failed P-CSCF from a network repository function (NRF). The profile of the failed P-CSCF comprises address information of Mw interface of the failed P-CSCF and address information of Gm interface of the failed P-CSCF. Then the SMF may derive address information of Gm interface of the failed P-CSCF based on the information of the failed P-CSCF and the profile of the failed P-CSCF. The SMF sends Updated P-CSCF list (without failed P-CSCF) to UE by AMF if UE indicates supports P-CSCF restoration in ePCO during the session establishment procedure.

The messages of FIG. 11 may be same as the corresponding messages as described in clause 5.8.4 of 3GPP TS 23.380 V17.0.0 except that some messages of FIG. 11 are enhanced based on the embodiments of the present disclosure. For example, some messages of FIG. 11 comprise failedPcscfOfMw.

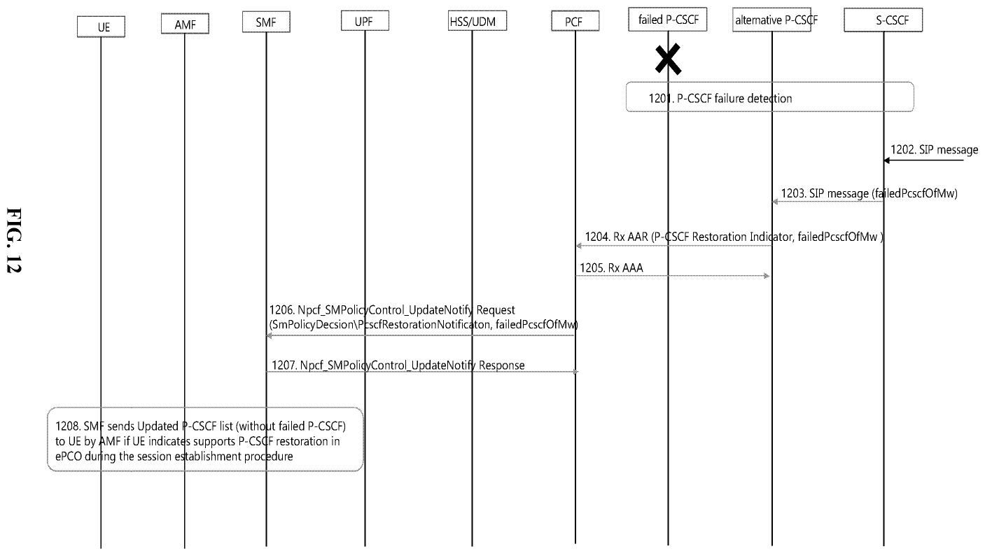

FIG. 12 shows a flowchart of P-CSCF restoration improvement on N7 Interface according to an embodiment of the present disclosure.

N7 is a reference point between the SMF and the PCF.

At step 1201, the S-CSCF knows that a P-CSCF is failed by P-CSCF failure detection mechanism.

At step 1202, the S-CSCF receives SIP message.

At step 1203, the S-CSCF sends SIP message with failedPcscfOfMw to an alternative P-CSCF.

At step 1204, the alternative P-CSCF sends Rx AAR with P-CSCF Restoration Indicator and failedPcscfOfMw to the PCF.

At step 1205, the PCF sends Rx AAA to the P-CSCF.

At step 1206, the PCF sends Npcf_SMPolicyControl_UpdateNotify Request (SmPolicyDecsion\PcscfRestorationNotificaton, failedPcscfOfMw) to the SMF.

At step 1207, the SMF sends Npcf_SMPolicyControl_UpdateNotify Response to PCF.

At step 1208, the SMF will find the corresponding P-CSCF address of the Gm interface. In an embodiment, the SMF will find the corresponding P-CSCF address of the Gm interface by local mapping table of P-CSCF address information on Mw interface and P-CSCF address information on Gm interface. In another embodiment, the SMF may receive a profile of the failed P-CSCF from a network repository function (NRF). The profile of the failed P-CSCF comprises address information of Mw interface of the failed P-CSCF and address information of Gm interface of the failed P-CSCF. Then the SMF may derive address information of Gm interface of the failed P-CSCF based on the information of the failed P-CSCF and the profile of the failed P-CSCF. The SMF sends Updated P-CSCF list (without failed P-CSCF) to UE by AMF if UE indicates supports P-CSCF restoration in ePCO during the session establishment procedure.

The messages of FIG. 12 may be same as the corresponding messages as described in clause 5.8.5 of 3GPP TS 23.380 V17.0.0 except that some messages of FIG. 12 are enhanced based on the embodiments of the present disclosure. For example, some messages of FIG. 12 comprise failedPcscfOfMw.

Some messages of FIGS. 11-12 may be same as the corresponding messages as described in 3GPP TS 23.502 V17.2.1. Some messages of FIGS. 11-12 are enhanced based on the embodiments of the present disclosure.

In an embodiment, the SMF may use the existing failed P-CSCF information from S-CSCF instead of SMF detecting the P-CSCF failure periodically.

In an embodiment, when UDM sends P-CSCF restoration notification request to AMF/SMF, currently it only sends the SUPI of the UE, but it is also useful to include the address of the failed P-CSCF. This way, the receiver of the notification (e.g., the SMF) can directly know the failed P-CSCF and need not rely on a periodical detection procedure, in order to include an updated available P-CSCF list to the UE.

In an embodiment, it may include a “failedPcscfOfMw” attribute (containing P-CSCF Address such as IP addresses of the failed P-CSCF) in the notification request from UDM to SMF or AMF

In an embodiment, it may include a “failedPcscfOfMw” attribute (containing P-CSCF Address such as IP addresses of the failed P-CSCF) in the restoration trigger request message from HSS to UDM.

In an embodiment, Table 6.2.6.2.9-1 of 3GPP TS 29.503 V17.5.0 may be amended as following.

TABLE 6.2.6.2.9-1
Definition of type PcscfRestorationNotification

| | | | Cardi- | |
|---|---|---|---|---|
| Attribute name | Data type | P | nality | Description |
| supi | Supi | M | 1 | A SUPI that is served |
| | | | | by the failed P-CSCF |
| failedPcscfOfMw | PcscfAddress | C | 0 . . . 1 | Information about the |
| | | | | failed P-CSCF on Mw |
| | | | | Interface |

In an embodiment, Table 6.2.6.2.12-1 of 3GPP TS 29.503 V17.5.0 may be amended as following.

TABLE 6.2.6.2.12-1
Definition of type TriggerRequest

| | | | Cardi- | |
|---|---|---|---|---|
| Attribute name | Data type | P | nality | Description |
| supi | Supi | M | 1 | |
| failedPcscfOfMw | PcscfAddress | C | 0 . . . 1 | Information about the |
| | | | | failed P-CSCF on Mw |
| | | | | Interface |

In an embodiment, Table 6.2.6.2.x-1 may be added into 3GPP TS 29.503 V17.5.0.

TABLE 6.2.6.2.x-1
Definition of type PcscfAddress

| Attribute name | Data type | P | Cardinality | Description |
|---|---|---|---|---|
| ipv4Addrs | array(Ipv4Addr) | O | 0 . . . 1 | If present, it contains IPv4 address(es) of the P-CSCF. |
| ipv6Addrs | array(Ipv6Addr) | O | 0 . . . 1 | If present, it contains IPv6 address(es) of the P-CSCF. |
| FQDN | FQDN | O | 0 . . . 1 | If present, it contains the FQDN of the P-CSCF. |
| NF instance ID | NF instance ID | O | 0 . . . 1 | If present, it contains a network function instance |
| | | | | identifier of the P-CSCF |

NOTE:
At least, one of these P-CSCF addressing attributes shall be included.

In an embodiment, the following content may be added into Table 6.2.6.1-1 of 3GPP TS 29.503 V17.5.0.

TABLE 6.2.6.1-1
Nudm_UECM specific Data Types

| | Clause | |
|---|---|---|
| Data type | defined | Description |
| PcscfAddress | 6.2.6.2.x | Contains the addressing information |
| | | (IP addresses and/or FQDN and/or |
| | | NF instance ID) of the P-CSCF |

In an embodiment, Nudm_UECM API of 3GPP TS 29.503 V17.5.0 may be amended as following.

A.3 Nudm_UECM API

```
(... text not shown for clarity ...)
    PcscfRestorationNotification:
      type: object
      required:
        - supi
      properties:
        supi:
          $ref: ′TS29571_CommonData.yaml #/components/schemas/Supi′
        failedPcscf:
          $ref: ′#/components/schemas/pcscfAddress′
    NetworkNodeDiameterAddress:
      type: object
      required:
        - name
        - realm
      properties:
        name:
          $ref: ′TS29571_CommonData.yaml#/components/schemas/DiameterIdentity′
        realm:
          $ref: ′TS29571_CommonData.yaml #/components/schemas/DiameterIdentity′
    TriggerRequest:
      type: object
      required:
        - supi
      properties:
        supi:
          $ref: ′TS29571_CommonData.yaml#/components/schemas/Supi′
        failedPcscf:
          $ref: ′#/components/schemas/pcscfAddress′
(... text not shown for clarity ...)
    SmfRegistrationModification:
      description: Contains attributes of SmfRegistration that can be modified using PATCH
      type: object
      required:
        - smfInstanceId
      properties:
        smfInstanceId:
          $ref: ′TS29571_CommonData.yaml#/components/schemas/NfInstanceId′
        pgwFqdn:
          type: string
          nullable: true
    PcscfAddress:
      description: Contains the addressing information (IP addresses and/or FQDN) of the P-CSCF
      type: object
      anyOf:
        - required: [ipv4Addrs]
        - required: [ipv6Addrs]
        - required: [fqdn]
        - required: [NF instance ID]
      properties:
        ipv4Addrs:
          type: array
          items:
            $ref: ′TS29571_CommonData.yaml#/components/schemas/Ipv4Addr′
          minItems: 1
        ipv6Addrs:
          type: array
          items:
            $ref: ′TS29571_CommonData.yaml#/components/schemas/Ipv6Addr′
          minItems: 1
        fqdn:
          $ref: ′TS29510_Nnrf_NFManagement.yaml#/components/schemas/Fqdn′
        NF instance ID:
  # SIMPLE TYPES:
```

In an embodiment, the following content may be added into Table 5.6.2.4-1 of 3GPP TS 29.512 V17.5.0.

TABLE 5.6.2.4-1
Definition of type SmPolicyDecision

| Attribute name | Data type | P | Cardinality | Description | Applicability |
|---|---|---|---|---|---|
| failedPcscfOfMw | PcscfAddress | C | 0 . . . 1 | Information about the failed | PCSCF-Restoration- |
| | | | | P-CSCF on the Mw Interface | Enhancement |

In an embodiment, Table 6.2.6.2.x-1 may be added into 3GPP TS 29.512 V17.5.0.

TABLE 6.2.6.2.x-1
Definition of type PcscfAddress

| Attribute name | Data type | P | Cardinality | Description |
|---|---|---|---|---|
| ipv4Addrs | array(Ipv4Addr) | O | 0 . . . 1 | If present, it contains IPv4 address(es) of the P-CSCF. |
| ipv6Addrs | array(Ipv6Addr) | O | 0 . . . 1 | If present, it contains IPv6 address(es) of the P-CSCF. |
| FQDN | FQDN | O | 0 . . . 1 | If present, it contains the FQDN of the P-CSCF. |
| NF instance ID | NF instance ID | O | 0 . . . 1 | If present, it contains a network function instance |
| | | | | identifier of the P-CSCF |

NOTE:
At least, one of these P-CSCF addressing attributes shall be included.

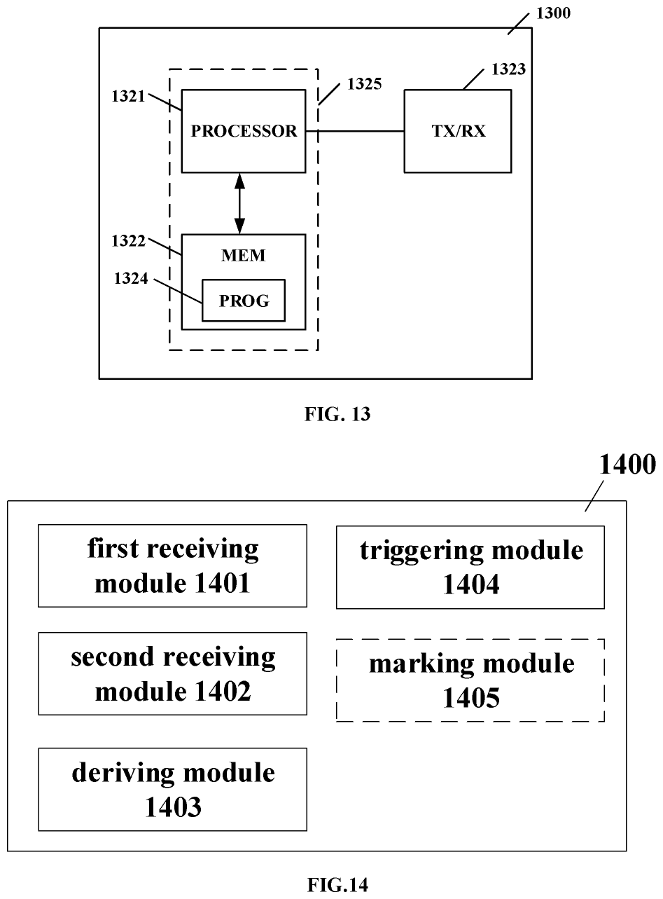

FIG. 13 is a block diagram showing an apparatus suitable for practicing some embodiments of the disclosure. For example, any one of the session management node, the data management node, the policy control node, or the access and mobility node described above may be implemented as or through the apparatus 1300.

The apparatus 1300 comprises at least one processor 1321, such as a digital processor (DP), and at least one memory (MEM) 1322 coupled to the processor 1321. The apparatus 1300 may further comprise a transmitter TX and receiver RX 1323 coupled to the processor 1321. The MEM 1322 stores a program (PROG) 1324. The PROG 1324 may include instructions that, when executed on the associated processor 1321, enable the apparatus 1300 to operate in accordance with the embodiments of the present disclosure. A combination of the at least one processor 1321 and the at least one MEM 1322 may form processing means 1313 adapted to implement various embodiments of the present disclosure.

Various embodiments of the present disclosure may be implemented by computer program executable by one or more of the processor 1321, software, firmware, hardware or in a combination thereof.

The MEM 1322 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 1321 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the session management node, the memory 1322 contains instructions executable by the processor 1321, whereby the session management node operates according to any of the methods related to the session management node as described above.

In an embodiment where the apparatus is implemented as or at the data management node, the memory 1322 contains instructions executable by the processor 1321, whereby the data management node operates according to any of the methods related to the data management node as described above.

In an embodiment where the apparatus is implemented as or at the policy control node, the memory 1322 contains instructions executable by the processor 1321, whereby the policy control node operates according to any of the methods related to the policy control node as described above.

In an embodiment where the apparatus is implemented as or at the access and mobility node, the memory 1322 contains instructions executable by the processor 1321, whereby the access and mobility node operates according to any of the methods related to the access and mobility node as described above.

FIG. 14 is a block diagram showing a session management node according to an embodiment of the disclosure. As shown, the session management node 1400 comprises a first receiving module 1401 configured to receive a message from a data management node or a policy control node or a first access and mobility node. The message may indicate proxy call session control function (P-CSCF) restoration and information of a failed P-CSCF. The session management node 1400 further comprises a second receiving module 1402 configured to receive a profile of the failed P-CSCF from a network repository function (NRF). The profile of the failed P-CSCF may comprise address information of Mw interface of the failed P-CSCF and address information of Gm interface of the failed P-CSCF. The session management node 1400 further comprises a deriving module 1403 configured to derive address information of Gm interface of the failed P-CSCF based on the information of the failed P-CSCF and the profile of the failed P-CSCF. The session management node 1400 further comprises a triggering module 1404 configured to, for a protocol data unit, PDU, session, based on the received message, trigger a P-CSCF restoration procedure by sending a PDU session release command or a PDU session modification command to a user equipment via the first or a second access and mobility node. The PDU session modification command may comprise an updated P-CSCF list based on the information of the failed P-CSCF.

In an embodiment, the session management node 1400 further comprises a marking module 1405 configured to mark the failed P-CSCF as temporarily not available for a period of time. Information of the failed P-CSCF will not be sent to a user equipment when allocating a P-CSCF list for a user equipment during the period of time.

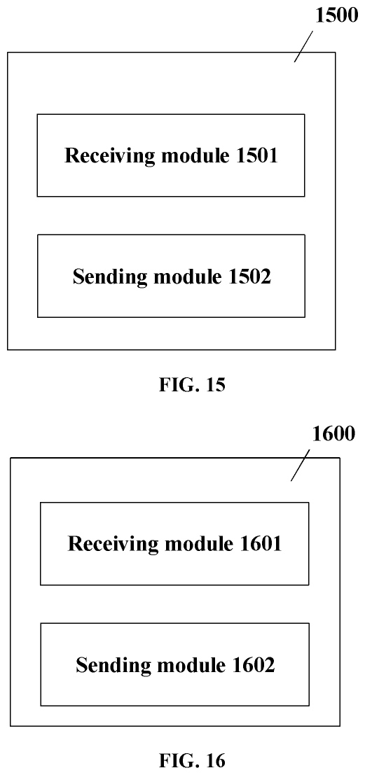

FIG. 15 is a block diagram showing a data management node according to an embodiment of the disclosure. As shown, the data management node 1500 comprises a receiving module 1501 configured to receive a request for initiating proxy call session control function (P-CSCF) restoration from a home subscriber server (HSS). The request comprises information of a failed P-CSCF. The data management node 1500 further comprises a sending module 1502 configured to send a message to a session management node or an access and mobility node. The message indicates proxy call session control function (P-CSCF) restoration and information of a failed P-CSCF.

FIG. 16 is a block diagram showing a policy control node according to an embodiment of the disclosure. As shown, the policy control node 1600 comprises a receiving module 1601 configured to receive a request from an alternative proxy call session control function (P-CSCF). The request comprises a P-CSCF restoration indicator and information of a failed P-CSCF. The policy control node 1600 further comprises a sending module 1602 configured to send a message to a session management node. The message indicates proxy call session control function (P-CSCF) restoration and information of a failed P-CSCF.

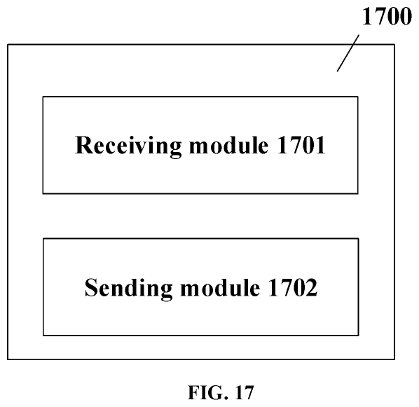

FIG. 17 is a block diagram showing an access and mobility node according to an embodiment of the disclosure. As shown, the access and mobility node 1700 comprises a receiving module 1701 configured to receive a message from a data management node. The message indicates proxy call session control function (P-CSCF) restoration and information of a failed P-CSCF. The access and mobility node 1700 further comprises a sending module 1702 configured to send a request to a session management node. The request indicates the P-CSCF restoration and the information of the failed P-CSCF.

In the above embodiments, the SMF will find the corresponding P-CSCF address information on Gm interface of the failed P-CSCF by a local mapping table of P-CSCF address information on Mw interface and P-CSCF address information on Gm interface. Then the SMF can directly know the failed P-CSCF address information and need not do the periodical detection, the SMF can perform Network triggered PDU session modification procedure to include the available P-CSCF list without the failed P-CSCF.

However the local mapping table for P-CSCF address information on Mw interface and P-CSCF address information on Gm interface is not efficient and is difficult and cost for the normal maintenance. To overcome or mitigate at least one of above mentioned problems or other problems, an improved solution for P-CSCF information registration may be desirable.

In an embodiment, when P-CSCF registers to the NRF, the P-SCSF includes pcscfInfo with at least one of the following Mw interface information: FQDN of the P-CSCF for the Mw interface, IPv4 address(es) of the P-CSCF for the Mw interface, IPV6 address(es) of the P-CSCF for the Mw interface. The SMF can get the pcscfInfo with these new parameters by NRF discovery for P-CSCF. The SMF will find the corresponding failed P-CSCF address of the Gm interface by the received pcscfInfo.

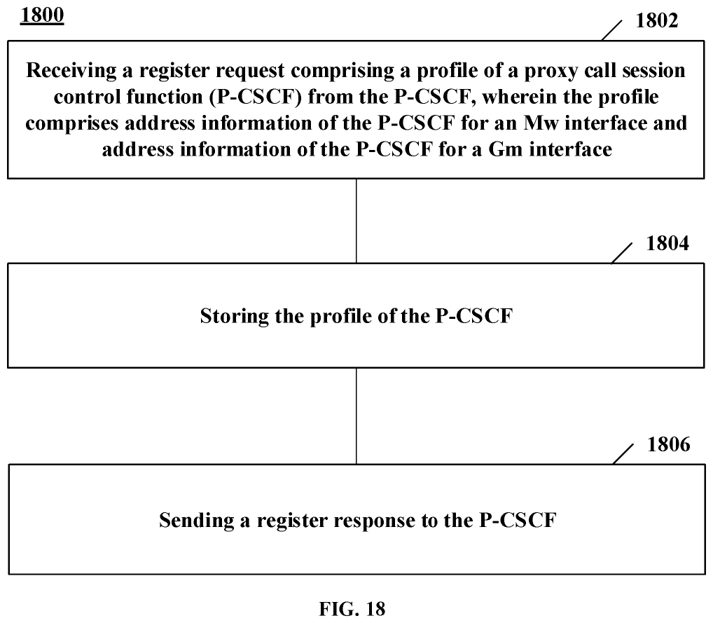

FIG. 18 shows a flowchart of a method according to another embodiment of the present disclosure, which may be performed by an apparatus implemented in or at or as a first network repository function (NRF) or communicatively coupled to the first NRF. As such, the apparatus may provide means or modules for accomplishing various parts of the method 1800 as well as means or modules for accomplishing other processes in conjunction with other components.

At block 1802, the first NRF may receive a register request comprising a profile of a P-CSCF from the P-CSCF. The profile comprises address information of the P-CSCF for an Mw interface and address information of the P-CSCF for a Gm interface.

The profile may further comprise any other suitable information such as table 1.

For example, the P-CSCF may send the register request to NRF to inform the NRF of its NF profile when the P-CSCF becomes operative for the first time. See table 1 for relevant NF profile parameters of the P-CSCF. In this embodiment, the profile further comprises address information of the P-CSCF for an Mw interface.

In an embodiment, the register request is Nnrf_NFManagement_NFRegister Request as described in 3GPP TS 23.502 V17.2.1.

At block 1804, the first NRF may store the profile of the P-CSCF. The first NRF may mark the P-CSCF available.

At block 1806, the first NRF may send a register response to the P-CSCF. For example, the NRF may acknowledge NF registration is accepted via the register response.

In an embodiment, the register response is Nnrf_NFManagement_NFRegister response as described in 3GPP TS 23.502 V17.2.1.

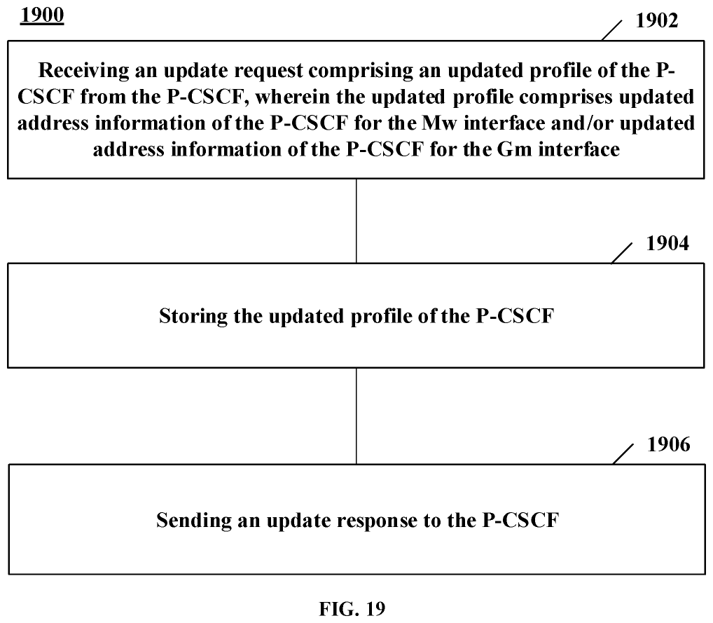

FIG. 19 shows a flowchart of a method according to another embodiment of the present disclosure, which may be performed by an apparatus implemented in or at or as a first NRF or communicatively coupled to the first NRF. As such, the apparatus may provide means or modules for accomplishing various parts of the method 1900 as well as means or modules for accomplishing other processes in conjunction with other components. For some parts which have been described in the above embodiments, the description thereof is omitted here for brevity.

At block 1902, the first NRF may receive an update request comprising an updated profile of the P-CSCF from the P-CSCF. The updated profile comprises updated address information of the P-CSCF for the Mw interface and/or updated address information of the P-CSCF for the Gm interface.

For example, the P-CSCF sends the update request (the updated NF profile of the P-CSCF) to NRF to inform the NRF of its updated NF profile (e.g. with updated address information of the P-CSCF for the Mw interface and/or updated address information of the P-CSCF for the Gm interface).

In an embodiment, the updated profile may further comprise any other suitable information such as table 1.

In an embodiment, the update request is Nnrf_NFManagement_NFUpdate Request as described in 3GPP TS 23.502 V17.2.1.

At block 1904, the first NRF may store the updated profile of the P-CSCF.

At block 1906, the first NRF may send an update response to the P-CSCF. For example, the NRF may acknowledge NF update is accepted via the update response.

In an embodiment, the update response is Nnrf_NFManagement_NFUpdate response as described in 3GPP TS 23.502 V17.2.1.

In an embodiment, the address information of the P-CSCF for the Mw interface comprises at least one of Internet protocol version 4 address of the P-CSCF for the Mw interface, Internet protocol version 6 address of the P-CSCF for the Mw interface, or fully qualified domain name of the P-CSCF for the Mw interface.

In an embodiment, the address information of the P-CSCF for the Gm interface comprises at least one of Internet protocol version 4 address of the P-CSCF for the Gm interface, Internet protocol version 6 address of the P-CSCF for the Gm interface, or fully qualified domain name of the P-CSCF for the Gm interface.

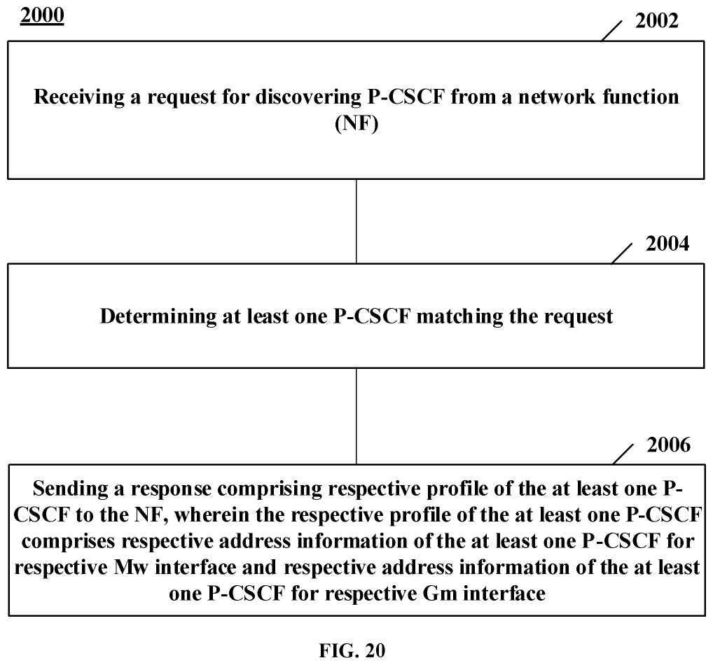

FIG. 20 shows a flowchart of a method according to another embodiment of the present disclosure, which may be performed by an apparatus implemented in or at or as a first NRF or communicatively coupled to the first NRF. As such, the apparatus may provide means or modules for accomplishing various parts of the method 2000 as well as means or modules for accomplishing other processes in conjunction with other components. For some parts which have been described in the above embodiments, the description thereof is omitted here for brevity.

At block 2002, the first NRF may receive a request for discovering proxy call session control function (P-CSCF) from a network function (NF).

The network function may be any suitable network function which requires to obtain the respective profile of at least one P-CSCF matching the request.

In an embodiment, the NF comprises at least one of a service communication proxy (SCP), a session management function (SMF), a second NRF, a serving CSCF (S-CSCF), a policy control function (PCF), or a unified data management (UDM).

The request may be any suitable request which can be sent from the NF to the first NRF. For example, the request may be an existing request or a new request.

In an embodiment, the request is Nnrf_NFDiscovery_Request as described in 3GPP TS 23.502 V17.2.1.

The request may further comprise any other suitable information which can be used by the first NRF to discover the P-CSCF. For example, the following factors may be considered during the P-CSCF discovery and selection: S-NSSAI (Single Network Slice Selection Assistance Information) of the PDU Session, UE location information. Local operator policies, Availability of candidate P-CSCFs, UE IP address, Access Type, Proximity to location of selected UPF, or Selected Data Network Name (DNN), etc.

At block 2004, the first NRF may determine at least one P-CSCF matching the request. For example, the first NRF may determine at least one P-CSCF matching the request and internal policies of the first NRF.

In an embodiment, the first NRF may authorize the request before performing block 2004. For example, based on the profile of the expected NF/NF service (e.g., P-CSCF service) and the type of the NF service consumer (e.g., the network function), the first NRF determines whether the NF service consumer is allowed to discover the expected NF instance(s). If the expected NF instance(s) or NF service instance(s) are deployed in a certain network slice, NRF authorizes the discovery request according to the discovery configuration of the Network Slice, e.g. the expected NF instance(s) are only discoverable by the NF in the same network slice. If the NF service consumer is allowed to discover the expected NF instance(s), the first NRF may determine at least one P-CSCF matching the request. Otherwise, the first NRF may reject the request.

In an embodiment, when the information of P-CSCF is stored in the first NRF or can be accessed by the first NRF, the first NRF may determine at least one P-CSCF matching the request by itself.

In an embodiment, the first NRF may interact with another NRF to obtain respective profile of at least one P-CSCF matching the request.

At block 2006, the first NRF may send a response comprising respective profile of the at least one P-CSCF to the NF. The respective profile of the at least one P-CSCF comprises respective address information of the at least one P-CSCF for respective Mw interface and respective address information of the at least one P-CSCF for respective Gm interface.

In an embodiment, the profile of a P-CSCF may further comprise any other suitable information such as table 1.

The response may be any suitable response which can be sent from the first NRF to the network function. For example, the response may be an existing response or a new response.

In an embodiment, the response is Nnrf_NFDiscovery_Request Response as described in 3GPP TS 23.502 V17.2.1.

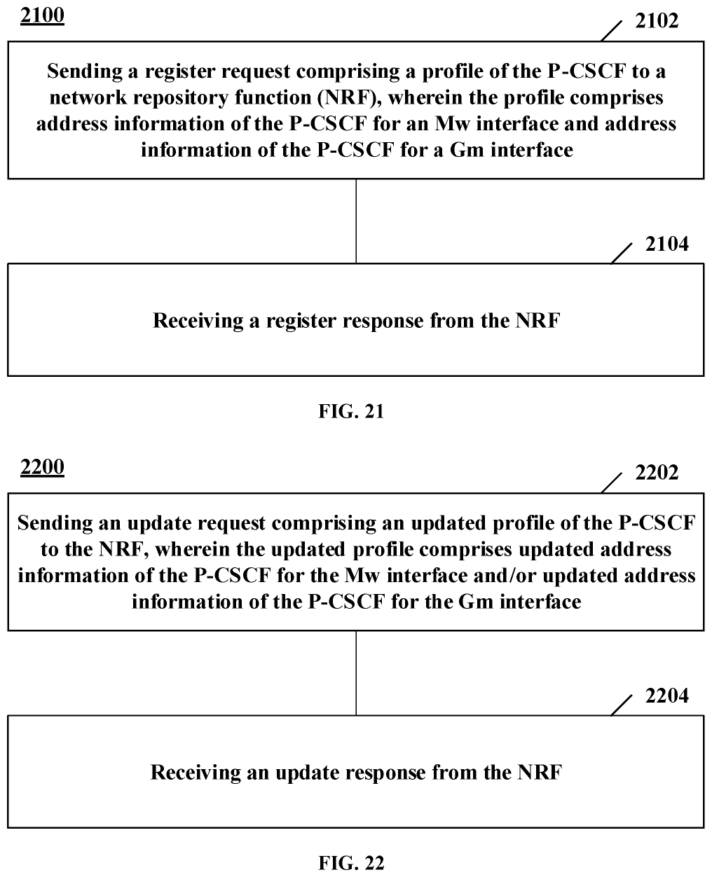

FIG. 21 shows a flowchart of a method according to another embodiment of the present disclosure, which may be performed by an apparatus implemented in or at or as a P-CSCF or communicatively coupled to the P-CSCF. As such, the apparatus may provide means or modules for accomplishing various parts of the method 2100 as well as means or modules for accomplishing other processes in conjunction with other components. For some parts which have been described in the above embodiments, the description thereof is omitted here for brevity.

At block 2102, the P-CSCF may send a register request comprising a profile of the P-CSCF to a network repository function (NRF). The profile comprises address information of the P-CSCF for an Mw interface and address information of the P-CSCF for a Gm interface.

In an embodiment, the profile of the P-CSCF may further comprise any other suitable information such as table 1.

In an embodiment, the address information of the P-CSCF for the Mw interface comprises at least one of Internet protocol version 4 address of the P-CSCF for the Mw interface, Internet protocol version 6 address of the P-CSCF for the Mw interface, or fully qualified domain name of the P-CSCF for the Mw interface.

In an embodiment, the address information of the P-CSCF for the Gm interface comprises at least one of Internet protocol version 4 address of the P-CSCF for the Gm interface, Internet protocol version 6 address of the P-CSCF for the Gm interface, or fully qualified domain name of the P-CSCF for the Gm interface.

At block 2104, the P-CSCF may receive a register response from the NRF.

In an embodiment, the register request is Nnrf_NFManagement_NFRegister Request and the register response is Nnrf_NFManagement_NFRegister response.

FIG. 22 shows a flowchart of a method according to another embodiment of the present disclosure, which may be performed by an apparatus implemented in or at or as a P-CSCF or communicatively coupled to the P-CSCF. As such, the apparatus may provide means or modules for accomplishing various parts of the method 2200 as well as means or modules for accomplishing other processes in conjunction with other components. For some parts which have been described in the above embodiments, the description thereof is omitted here for brevity.

At block 2202, the P-CSCF may send an update request comprising an updated profile of the P-CSCF to the NRF. The updated profile comprises updated address information of the P-CSCF for the Mw interface and/or updated address information of the P-CSCF for the Gm interface.

In an embodiment, the updated profile of the P-CSCF may further comprise any other suitable information such as table 1.

At block 2204, the P-CSCF may receive an update response from the NRF.

In an embodiment, the update request is Nnrf_NFManagement_NFUpdate Request and the update response is Nnrf_NFManagement_NFUpdate response.

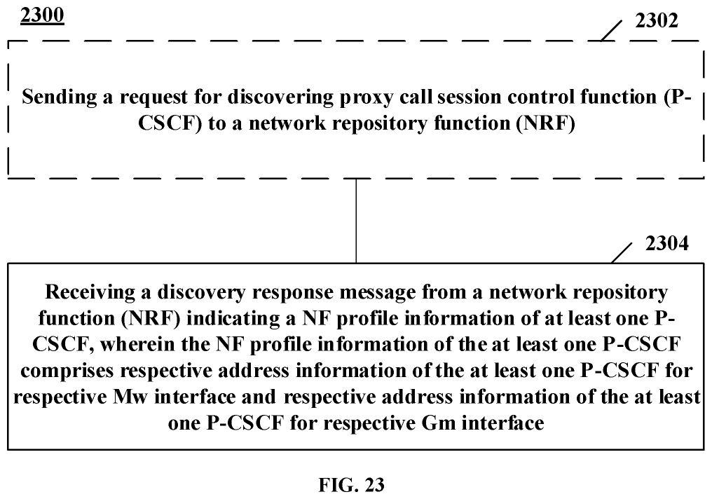

FIG. 23 shows a flowchart of a method according to another embodiment of the present disclosure, which may be performed by an apparatus implemented in or at or as a network function or communicatively coupled to the network function. As such, the apparatus may provide means or modules for accomplishing various parts of the method 2300 as well as means or modules for accomplishing other processes in conjunction with other components. For some parts which have been described in the above embodiments, the description thereof is omitted here for brevity.

At block 2302, optionally, the network function may send a request for discovering proxy call session control function (P-CSCF) to a network repository function (NRF).

The NF may be any suitable NF such as NFs as described in 3GPP TS 23.502 V17.2.1. In an embodiment, the NF comprises at least one of a service communication proxy (SCP), a session management function (SMF), a second NRF, a serving CSCF (S-CSCF), a policy control function (PCF), or a unified data management (UDM).

At block 2304, the network function may receive a discovery response message from a network repository function (NRF) indicating a NF profile information of at least one P-CSCF.

In an embodiment, the NF profile information of the at least one P-CSCF may comprise respective address information of the at least one P-CSCF for respective Mw interface and respective address information of the at least one P-CSCF for respective Gm interface.

In an embodiment, the Gm interface defines an interface between a P-CSCF and a user equipment and the Mw interface defines an interface between a P-CSCF and other CSCF.

For example, the network function may receive a response comprising respective profile of at least one P-CSCF from the NRF. The respective profile of the at least one P-CSCF comprises respective address information of the at least one P-CSCF for respective Mw interface and respective address information of the at least one P-CSCF for respective Gm interface.

In an embodiment, the respective profile of the at least one P-CSCF may further comprise any other suitable information such as table 1.

In an embodiment, the request is Nnrf_NFDiscovery_Request and the response is Nnrf_NFDiscovery_Request Response.

In an embodiment, address information of a P-CSCF for Mw interface may comprise at least one of Internet protocol version 4 address of the P-CSCF for the Mw interface, Internet protocol version 6 address of the P-CSCF for the Mw interface, or fully qualified domain name of the P-CSCF for the Mw interface.

In an embodiment, address information of a P-CSCF for Gm interface may comprise at least one of Internet protocol version 4 address of the P-CSCF for the Gm interface, Internet protocol version 6 address of the P-CSCF for the Gm interface, or fully qualified domain name of the P-CSCF for the Gm interface.

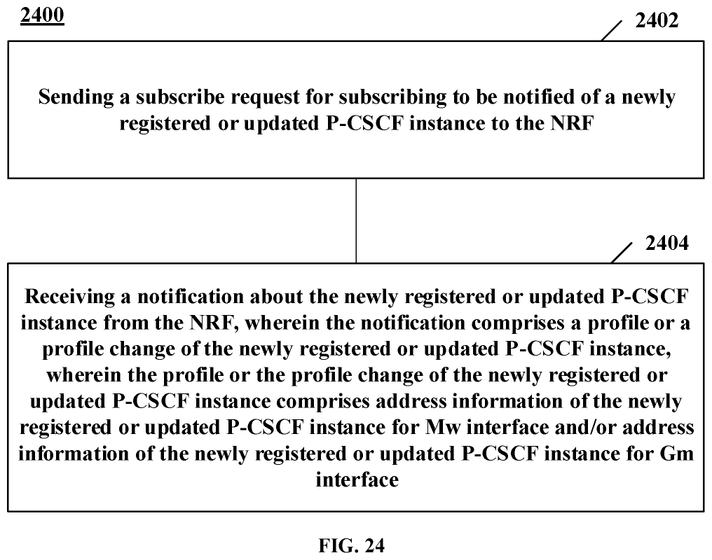

FIG. 24 shows a flowchart of a method according to another embodiment of the present disclosure, which may be performed by an apparatus implemented in or at or as a network function or communicatively coupled to the network function. As such, the apparatus may provide means or modules for accomplishing various parts of the method 2400 as well as means or modules for accomplishing other processes in conjunction with other components. For some parts which have been described in the above embodiments, the description thereof is omitted here for brevity.

At block 2402, the network function may send a subscribe request for subscribing to be notified of a newly registered or updated P-CSCF instance to the NRF.

At block 2404, the network function may receive a notification about the newly registered or updated P-CSCF instance from the NRF.

In an embodiment, the notification comprises a profile or a profile change of the newly registered or updated P-CSCF instance.

In an embodiment, the profile or the profile change of the newly registered or updated P-CSCF instance may comprise address information of the newly registered or updated P-CSCF instance for Mw interface and/or address information of the newly registered or updated P-CSCF instance for Gm interface.

In an embodiment, the subscribe request is Nnrf_NFManagement_NFStatusSubscribe Request and the notification is Nnrf_NFManagement_NFStatusNotify as described in 3GPP TS 23.502 V17.2.1.

For example, the NF may subscribe to be notified of newly registered/updated NF instances along with its NF services. The NF invokes Nnrf_NFManagement_NFStatusSubscribe Request from an appropriate configured NRF. The NRF may authorize the Nnrf_NFManagement_NFStatusSubscribe Request. Based on the profile of the expected NF/NF service and the type of the NF service consumer, the NRF determines whether the NF is allowed to subscribe to the status of the target NF instance(s) or NF service instance(s). If allowed, the NRF acknowledges the execution of Nnrf_NFManagement_NFStatusSubscribe Request. NRF notifies about newly registered/updated/deregistered NF instances along with its NF services to the subscribed NF.

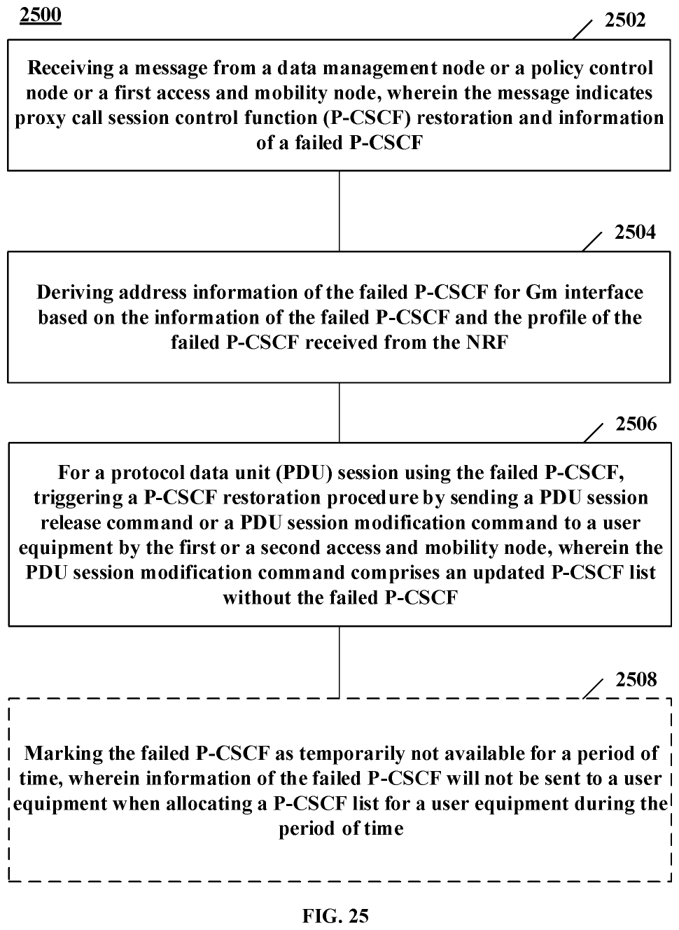

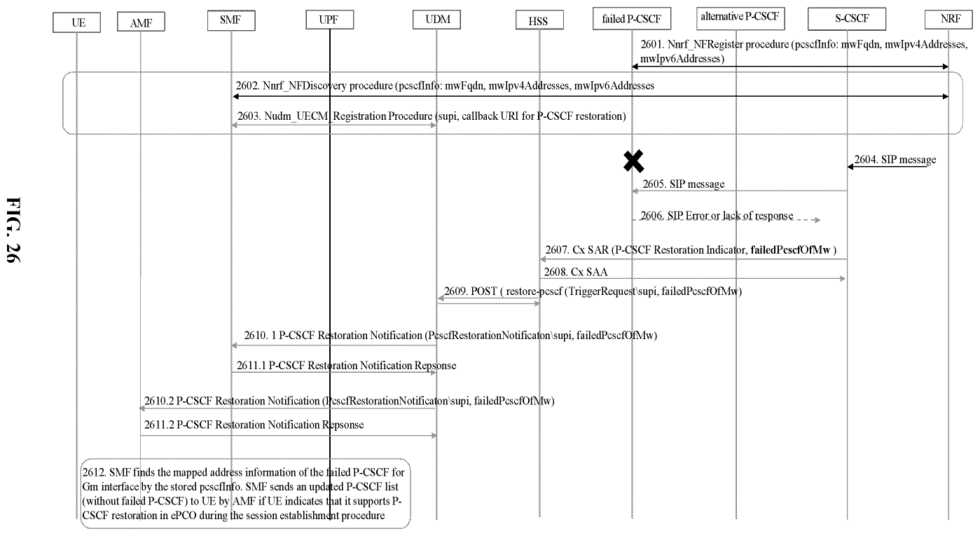

FIG. 25 shows a flowchart of a method according to another embodiment of the present disclosure, which may be performed by an apparatus implemented in or at or as a network function or communicatively coupled to the network function. As such, the apparatus may provide means or modules for accomplishing various parts of the method 2500 as well as means or modules for accomplishing other processes in conjunction with other components. For some parts which have been described in the above embodiments, the description thereof is omitted here for brevity. In this embodiment, the NF is a session management node such as SMF.

At block 2502, the network function may receive a message from a data management node or a policy control node or a first access and mobility node. The message indicates proxy call session control function (P-CSCF) restoration and information of a failed P-CSCF. Block 2502 is same as block 602 of FIG. 6.

In an embodiment, the information of the failed P-CSCF comprises at least one of Internet protocol version 4 address of Mw interface of the failed P-CSCF, a NF instance identifier of the failed P-CSCF, Internet protocol version 6 address of Mw interface of the failed P-CSCF, or fully qualified domain name of Mw interface of the failed P-CSCF.

At block 2504, the network function may derive address information of the failed P-CSCF for Gm interface based on the information of the failed P-CSCF and the profile of the failed P-CSCF received from the NRF.

For example, the network function may receive the profile of the failed P-CSCF at block 2504 of FIG. 22, or block 2304 of FIG. 23. The profile of the failed P-CSCF comprises address information of the failed P-CSCF for Mw interface and respective address information of the failed P-CSCF for Gm interface. Then the network function may derive address information of the failed P-CSCF for Gm interface based on the information of the failed P-CSCF and the profile of the failed P-CSCF received from the NRF.

At block 2506, for a protocol data unit (PDU) session using the failed P-CSCF, the NF may trigger a P-CSCF restoration procedure by sending a PDU session release command or a PDU session modification command to a user equipment by the first or a second access and mobility node. The PDU session modification command comprises an updated P-CSCF list without the failed P-CSCF. Block 2506 is same as block 604 of FIG. 6.

In an embodiment, the failed P-CSCF is detected by a serving CSCF (S-CSCF).

In an embodiment, when the message is received from the data management node, the message is Nudm_UECM_PCscfRestoration notification.

In an embodiment, when the message is received from the policy control node, the message is Npcf_SMPolicyControl_UpdateNotify Request.

In an embodiment, when the message is received from the first access and mobility node, the message is an Nsmf_PDUSession_UpdateSMContext Request.

In an embodiment, the session management node comprises session management function (SMF), the first and second access and mobility nodes comprise access and mobility function (AMF), the data management node comprises unified data management (UDM), and the policy control node comprises policy control function (PCF).

In an embodiment, the PDU session modification command is sent to the user equipment when the user equipment supports P-CSCF re-selection.

At block 2508, optionally, the network function may mark the failed P-CSCF as temporarily not available for a period of time. Information of the failed P-CSCF will not be sent to a user equipment when allocating a P-CSCF list for a user equipment during the period of time. Block 2508 is same as block 756 of FIG. 6.

FIG. 26 shows a flowchart of P-CSCF restoration improvement on N10 Interface according to an embodiment of the present disclosure.

N10 is a reference point between the UDM and the SMF.

When S-CSCF detects that a P-CSCF is failed, the S-CSCF informs HSS/UDM with P-CSCF restoration indicator and the failed P-CSCF information. The UDM will trigger P-CSCF restoration procedure. The UDM sends P-CSCF restoration notification request with a new attribute failedPcscfOfMw (the failed P-CSCF IP address/FQDN/Instance Id) to the SMF/AMF.

At step 2601, NF Service Registration procedure as described in 3GPP TS 23.502 V17.2.1 may be performed. For example, the P-CSCF sends Nnrf_NFManagement_NFRegister Request with pcscfInfo to NRF and receives Nnrf_NFManagement_NFRegister response from NRF. The pcscfInfo may comprise at least one of mwFqdn (fully qualified domain name of the P-CSCF for the Mw interface), mwIpv4Addresses (Internet protocol version 4 address of the P-CSCF for the Mw interface), or mwIpv6Addresses (Internet protocol version 6 address of the P-CSCF for the Mw interface).

At step 2602, a PDU Session Establishment procedure as described in 3GPP TS 23.502 V17.2.1 may be performed. During PDU session establishment procedure, the SMF performs Nnrf_NFDiscovery procedure and stores the received pcscfInfo. The pcscfInfo may comprise at least one of mwFqdn, mwIpv4Addresses, or mwIpv6Addresses.

At step 2603, the SMF sends Nudm_UECM_Registration Request (SUPI, callback URI (Uniform Resource Identifier) for P-CSCF restoration) to the UDM. The UDM sends Nudm_UECM_Registration Response to the SMF.

At step 2604, a P-CSCF has failed. The S-CSCF receives a SIP message.

At step 2605, the S-CSCF forwards the received SIP message to the failed P-CSCF.

At step 2606, the S-CSCF doesn't receive the response from the failed P-CSCF or receives SIP error information from the failed P-CSCF.

At step 2607, the S-CSCF sends Cx SAR (Server Assignment Request) with P-CSCF Restoration Indicator and failedPcscfOfMw) to the HSS. Cx is a reference point between a CSCF and an HSS as described in 3GPP TS 23.228 V17.3.0.

At step 2608, the HSS sends Cx SAA (Server-Assignment-Answer) to the S-CSCF.

At step 2609, the HSS sends POST (restore-pcscf (TriggerRequest\supi, failedPcscfOfMw) to the UDM. The UDM sends the response to HSS.

At step 2610.1, the UDM sends P-CSCF Restoration Notification (PcscfRestorationNotificaton\supi, failedPcscfOfMw) to the SMF.

At step 2611.1, the SMF sends P-CSCF Restoration Notification Response to the UDM.

At step 2610.2, the UDM sends P-CSCF Restoration Notification (PcscfRestorationNotificaton\supi, failedPcscfOfMw) to the AMF.

At step 2611.2, the AMF sends P-CSCF Restoration Notification Response to the UDM.

At step 2612, SMF finds the mapped address information of the failed P-CSCF for Gm interface by the stored pcscfInfo. SMF sends an updated P-CSCF list (without failed P-CSCF) to UE by AMF if UE indicates that it supports P-CSCF restoration in ePCO during the session establishment procedure. For example, the SMF finds (or derives) address information of the failed P-CSCF for Gm interface based on the information of the failed P-CSCF (e.g., failedPcscfOfMw) and the profile of the failed P-CSCF received from the NRF at step 2602. The SMF sends the updated P-CSCF list (without failed P-CSCF) to UE by AMF if UE indicates supports P-CSCF restoration in ePCO during the session establishment procedure.

The messages of FIG. 26 may be same as the corresponding messages as described in clause 5.8.4 of 3GPP TS 23.380 V17.0.0 except that some messages of FIG. 26 are enhanced based on the embodiments of the present disclosure. For example, some messages of FIG. 26 comprise failedPcscfOfMw. The profile of P-CSCF comprises address information of the P-CSCF for an Mw interface and address information of the P-CSCF for a Gm interface.

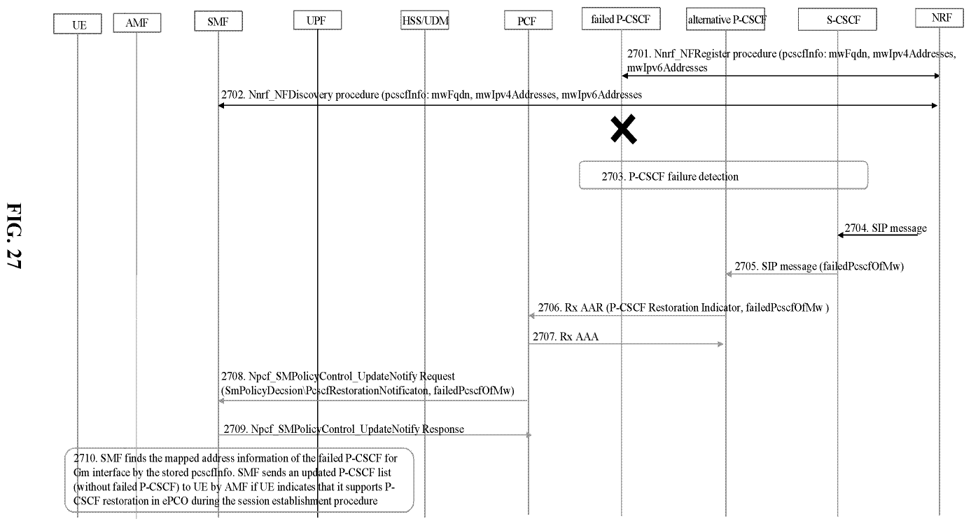

FIG. 27 shows a flowchart of P-CSCF restoration improvement on N7 Interface according to an embodiment of the present disclosure.

N7 is a reference point between the SMF and the PCF.

At step 2701, NF Service Registration procedure as described in 3GPP TS 23.502 V17.2.1 may be performed. For example, the P-CSCF sends Nnrf_NFManagement_NFRegister Request with pcscfInfo to NRF and receives Nnrf_NFManagement_NFRegister response from NRF. The pcscfInfo may comprise at least one of mwFqdn, mwIpv4Addresses, or mwIpv6Addresses.

At step 2702, a PDU Session Establishment procedure as described in 3GPP TS 23.502 V17.2.1 may be performed. During PDU session establishment procedure, the SMF performs Nnrf_NFDiscovery procedure and stores the received pcscfInfo. The pcscfInfo may comprise at least one of mwFqdn, mwIpv4Addresses, or mwIpv6Addresses.

At step 2703, the S-CSCF knows that a P-CSCF is failed by P-CSCF failure detection mechanism.

At step 2704, the S-CSCF receives SIP message.

At step 2705, the S-CSCF sends SIP message with failedPcscfOfMw to an alternative P-CSCF.

At step 2706, the alternative P-CSCF sends Rx AAR with P-CSCF Restoration Indicator and failedPcscfOfMw to the PCF.

At step 2707, the PCF sends Rx AAA to the P-CSCF.

At step 2708, the PCF sends Npcf_SMPolicyControl_UpdateNotify Request (SmPolicyDecsion\PcscfRestorationNotificaton, failedPcscfOfMw) to the SMF.

At step 2709, the SMF sends Npcf_SMPolicyControl_UpdateNotify Response to PCF.

At step 2710, SMF finds the mapped address information of the failed P-CSCF for Gm interface by the stored pcscfInfo. SMF sends an updated P-CSCF list (without failed P-CSCF) to UE by AMF if UE indicates that it supports P-CSCF restoration in ePCO during the session establishment procedure. For example, the SMF finds (or derives) address information of the failed P-CSCF for Gm interface based on the information of the failed P-CSCF (e.g., failedPcscfOfMw) and the profile of the failed P-CSCF received from the NRF at step 2702. The SMF sends the updated P-CSCF list (without failed P-CSCF) to UE by AMF if UE indicates supports P-CSCF restoration in ePCO during the session establishment procedure.

The messages of FIG. 27 may be same as the corresponding messages as described in clause 5.8.5 of 3GPP TS 23.380 V17.0.0 except that some messages of FIG. 27 are enhanced based on the embodiments of the present disclosure. For example, some messages of FIG. 27 comprise failedPcscfOfMw. The profile of P-CSCF comprises address information of the P-CSCF for an Mw interface and address information of the P-CSCF for a Gm interface.

Some messages of FIGS. 26-27 may be same as the corresponding messages as described in 3GPP TS 23.502 V17.2.1. Some messages of FIGS. 26-27 are enhanced based on the embodiments of the present disclosure.

In an embodiment, the SMF may use the existing failed P-CSCF information from S-CSCF instead of SMF detecting the P-CSCF failure periodically.

In an embodiment, when UDM sends P-CSCF restoration notification request to AMF/SMF, currently it only sends the SUPI of the UE, but it is also useful to include the address of the failed P-CSCF. This way, the receiver of the notification (e.g., the SMF) can directly know the failed P-CSCF and need not rely on a periodical detection procedure, in order to include an updated available P-CSCF list to the UE.

In an embodiment, it may include a “failedPcscfOfMw” attribute (containing P-CSCF Address such as IP addresses of the failed P-CSCF) in the notification request from UDM to SMF or AMF

In an embodiment, it may include a “failedPcscfOfMw” attribute (containing P-CSCF Address such as IP addresses of the failed P-CSCF) in the restoration trigger request message from HSS to UDM.

In an embodiment, Table 6.1.6.2.53-1 of 3GPP TS 29.510 V17.4.0 may be amended as following.

TABLE 6.1.6.2.53-1
Definition of type PcscfInfo

| Attribute name | Data type | P | Cardinality | Description |
|---|---|---|---|---|
| access Type | array(AccessType) | C | 1 . . . N | If included, this IE shall contain the access type |
| | | | | (3GPP_ACCESS and/or NON_3GPP_ACCESS) |
| | | | | supported by the P-CSCF. |
| | | | | If not included, it shall be assumed that all access types are |
| | | | | supported. |
| dnnList | array(Dnn) | O | 1 . . . N | DNNs supported by the P-CSCF. The DNN shall contain |
| | | | | the Network Identifier and it may additionally contain an |
| | | | | Operator Identifier. If the Operator Identifier is not included, |
| | | | | the DNN is supported for all the PLMNs in the plmnList of |
| | | | | the NF Profile. |
| | | | | If not provided, the P-CSCF can serve any DNN. |
| gmFqdn | Fqdn | O | 0 . . . 1 | FQDN of the P-CSCF for the Gm interface |
| gmIpv4Addresses | array(Ipv4Addr) | O | 1 . . . N | IPv4 address(es) of the P-CSCF for the Gm interface |
| gmIpv6Addresses | array(Ipv6Addr) | O | 1 . . . N | IPv6 address(es) of the P-CSCF for the Gm interface |
| servedIpv4AddressRanges | array(Ipv4AddressRange) | O | 1 . . . N | List of ranges of UE IPv4 addresses used on the Gm |
| | | | | interface, served by P-CSCF. |
| | | | | The absence of this attribute does not mean the P-CSCF |
| | | | | can serve any IPv4 address. |
| servedIpv6PrefixRanges | array(Ipv6PrefixRange) | O | 1 . . . N | List of ranges of UE IPv6 prefixes used on the Gm |
| | | | | interface, served by P-CSCF. |
| | | | | The absence of this attribute does not mean the P-CSCF |
| | | | | can serve any IPv6 prefix. |
| mwFqdn | Fqdn | O | 0 . . . 1 | FQDN of the P-CSCF for the Mw interface |
| mwIpv4Addresses | array(Ipv4Addr) | O | 1 . . . N | IPv4 address(es) of the P-CSCF for the Mw interface |
| mwIpv6Addresses | array(Ipv6Addr) | O | 1 . . . N | IPv6 address(es) of the P-CSCF for the Mw interface |

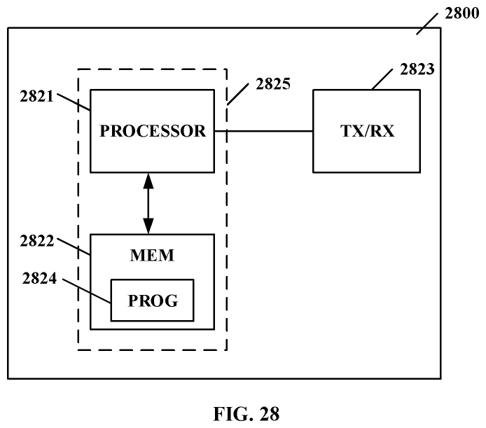

FIG. 28 is a block diagram showing an apparatus suitable for practicing some embodiments of the disclosure. For example, any one of the first NRF, the network function, or the P-CSCF described above may be implemented as or through the apparatus 2800.

The apparatus 2800 comprises at least one processor 2821, such as a digital processor (DP), and at least one memory (MEM) 2822 coupled to the processor 2821. The apparatus 2800 may further comprise a transmitter TX and receiver RX 2823 coupled to the processor 2821. The MEM 2822 stores a program (PROG) 2824. The PROG 2824 may include instructions that, when executed on the associated processor 2821, enable the apparatus 2800 to operate in accordance with the embodiments of the present disclosure. A combination of the at least one processor 2821 and the at least one MEM 2822 may form processing means 2813 adapted to implement various embodiments of the present disclosure.

Various embodiments of the present disclosure may be implemented by computer program executable by one or more of the processor 2821, software, firmware, hardware or in a combination thereof.

The MEM 2822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 2821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the first NRF, the memory 2822 contains instructions executable by the processor 2821, whereby the first NRF operates according to any of the methods related to the first NRF as described above.

In an embodiment where the apparatus is implemented as or at the network function, the memory 2822 contains instructions executable by the processor 2821, whereby the network function operates according to any of the methods related to the network function as described above.

In an embodiment where the apparatus is implemented as or at the P-CSCF, the memory 2822 contains instructions executable by the processor 2821, whereby the P-CSCF operates according to any of the methods related to the P-CSCF as described above.

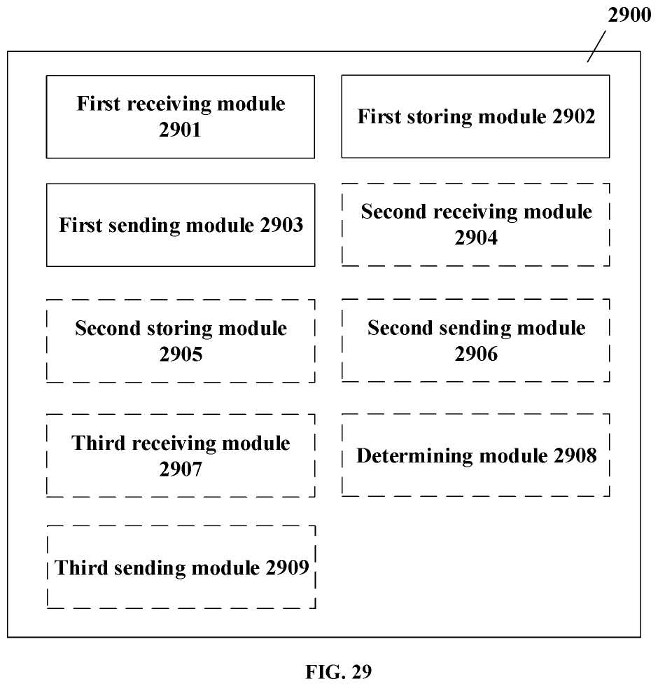

FIG. 29 is a block diagram showing a first NRF according to an embodiment of the disclosure. As shown, the first NRF 2900 comprises a first receiving module 2901 configured to receive a register request comprising a profile of a proxy call session control function (P-CSCF) from the P-CSCF. The profile comprises address information of the P-CSCF for an Mw interface and address information of the P-CSCF for a Gm interface. The first NRF 2900 further comprises a first storing module 2902 configured to store the profile of the P-CSCF. The first NRF 2900 further comprises a first sending module 2903 configured to send a register response to the P-CSCF.

In an embodiment, the first NRF 2900 further comprises a second receiving module 2904 configured to receive an update request comprising an updated profile of the P-CSCF from the P-CSCF. The updated profile comprises updated address information of the P-CSCF for the Mw interface and/or updated address information of the P-CSCF for the Gm interface. The first NRF 2900 further comprises a second storing module 2905 configured to store the updated profile of the P-CSCF. The first NRF 2900 further comprises a second sending module 2906 configured to send an update response to the P-CSCF.

In an embodiment, the first NRF 2900 further comprises a third receiving module 2907 configured to receive a request for discovering P-CSCF from a network function (NF). The first NRF 2900 further comprises a determining module 2908 configured to determine at least one P-CSCF matching the request. The first NRF 2900 further comprises a third sending module 2909 configured to send a response comprising respective profile of the at least one P-CSCF to the NF. The respective profile of the at least one P-CSCF comprises respective address information of the at least one P-CSCF for respective Mw interface and respective address information of the at least one P-CSCF for respective Gm interface.

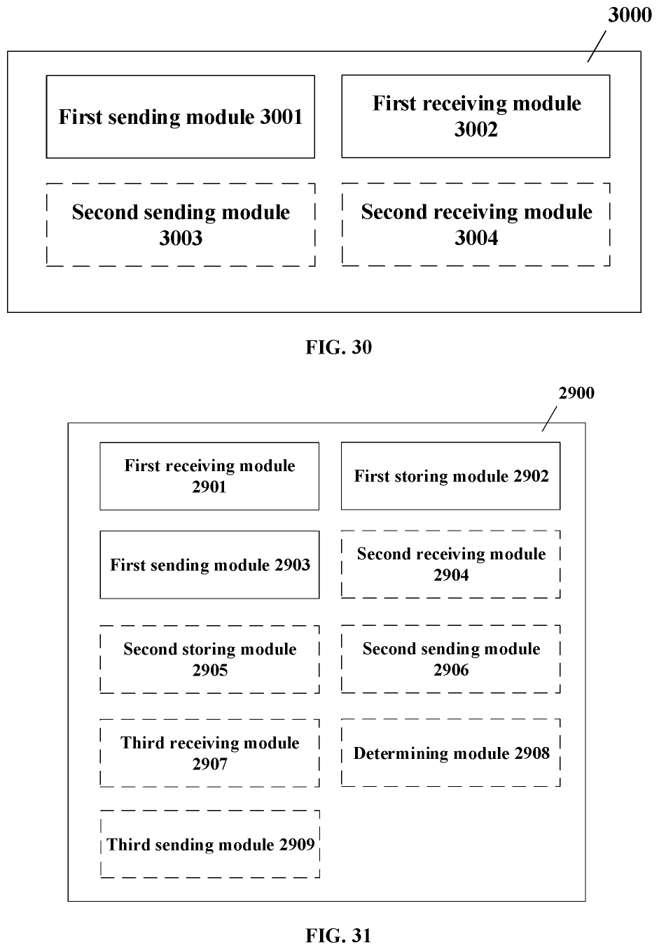

FIG. 30 is a block diagram showing a P-CSCF according to an embodiment of the disclosure. As shown, the P-CSCF 3000 comprises a first sending module 3001 configured to send a register request comprising a profile of the P-CSCF to a network repository function (NRF). The profile comprises address information of the P-CSCF for an Mw interface and address information of the P-CSCF for a Gm interface. The P-CSCF 3000 further comprises a first receiving module 3002 configured to receive a register response from the NRF.

In an embodiment, the P-CSCF 3000 further comprises a second sending module 3003 configured to send an update request comprising an update request comprising an updated profile of the P-CSCF to the NRF. The updated profile comprises updated address information of the P-CSCF for the Mw interface and/or updated address information of the P-CSCF for the Gm interface. The P-CSCF 3000 further comprises a second receiving module 3004 configured to receive an update response from the NRF.

FIG. 31 is a block diagram showing a network function according to an embodiment of the disclosure. As shown, the network function 3100 further comprises a first receiving module 3102 configured to receive a discovery response message from a network repository function (NRF) indicating a NF profile information of at least one P-CSCF. The NF profile information of the at least one P-CSCF may comprise respective address information of the at least one P-CSCF for respective Mw interface and respective address information of the at least one P-CSCF for respective Gm interface.

In an embodiment, the network function 3100 may further comprise a first sending module 3101 configured to send a request for discovering proxy call session control function (P-CSCF) to a network repository function (NRF).

In an embodiment, the network function 3100 further comprises a second sending module 3103 configured to send a subscribe request for subscribing to be notified of a newly registered or updated P-CSCF instance to the NRF. The network function 3100 further comprises a second receiving module 3104 configured to receive a notification about the newly registered or updated P-CSCF instance from the NRF. The notification comprises a profile or a profile change of the newly registered or updated P-CSCF instance. The profile or the profile change of the newly registered or updated P-CSCF instance comprises address information of the newly registered or updated P-CSCF instance for Mw interface and/or address information of the newly registered or updated P-CSCF instance for Gm interface.

In an embodiment, when the NF is a session management node, the network function 3100 further comprises a third receiving module 3105 configured to receive a message from a data management node or a policy control node or a first access and mobility node. The message indicates proxy call session control function (P-CSCF) restoration and information of a failed P-CSCF. The network function 3100 further comprises a deriving module 3106 configured to derive address information of the failed P-CSCF for Gm interface based on the information of the failed P-CSCF and the profile of the failed P-CSCF received from the NRF. The network function 3100 further comprises a triggering module 3107 configured to, for a protocol data unit (PDU) session using the failed P-CSCF, trigger a P-CSCF restoration procedure by sending a PDU session release command or a PDU session modification command to a user equipment by the first or a second access and mobility node. The PDU session modification command comprises an updated P-CSCF list without the failed P-CSCF.

In an embodiment, when the NF is a session management node, the network function 3100 further comprises a marking module 3108 configured to mark the failed P-CSCF as temporarily not available for a period of time. Information of the failed P-CSCF will not be sent to a user equipment when allocating a P-CSCF list for a user equipment during the period of time.

Embodiments herein may provide many advantages, of which a non-exhaustive list of examples follows. In some embodiments herein, it can directly use the existing failed P-CSCF information from a network function such as S-CSCF instead of SMF detecting the P-CSCF failure periodically. In some embodiments herein, it can keep the SMF simple. In some embodiments herein, it can reduce the load of SMF. In some embodiments herein, the SMF can find the corresponding failed P-CSCF address of the Gm interface by the received pcscfInfo, instead of local configured P-CSCF mapping table. The embodiments herein are not limited to the features and advantages mentioned above. A person skilled in the art will recognize additional features and advantages upon reading the following detailed description.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the session management node, the data management node, the policy control node, the access and mobility node, the first NRF, the network function, or the P-CSCF may not need a fixed processor or memory, any computing resource and storage resource may be arranged from the session management node, the data management node, the policy control node, the access and mobility node, the first NRF, the network function, or the P-CSCF in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1-12. (canceled)

13. A method performed by a first network repository function (NRF), comprising:
receiving a register request comprising a profile of a proxy call session control function (P-CSCF) from the P-CSCF, wherein the profile comprises address information of the P-CSCF for an Mw interface and address information of the P-CSCF for a Gm interface;
storing the profile of the P-CSCF; and
sending a register response to the P-CSCF.

14. The method according to claim 13, wherein the register request is Nnrf_NFManagement_NFRegister Request and the register response is Nnrf_NFManagement_NFRegister response.

15. The method according to claim 13, further comprising:
receiving an update request comprising an updated profile of the P-CSCF from the P-CSCF, wherein the updated profile comprises updated address information of the P-CSCF for the Mw interface and/or updated address information of the P-CSCF for the Gm interface;
storing the updated profile of the P-CSCF; and
sending an update response to the P-CSCF.

16. The method according to claim 15, wherein the update request is Nnrf_NFManagement_NFUpdate Request and the update response is Nnrf_NFManagement_NFUpdate response.

17. The method according to claim 13, wherein the address information of the P-CSCF for the Mw interface comprises at least one of:
Internet protocol version 4 address of the P-CSCF for the Mw interface,
Internet protocol version 6 address of the P-CSCF for the Mw interface, or
fully qualified domain name of the P-CSCF for the Mw interface.

18. The method according to claim 15, wherein the address information of the P-CSCF for the Gm interface comprises at least one of:
Internet protocol version 4 address of the P-CSCF for the Gm interface,
Internet protocol version 6 address of the P-CSCF for the Gm interface, or
fully qualified domain name of the P-CSCF for the Gm interface; and/or
wherein the Gm interface defines an interface between a P-CSCF and a user equipment and the Mw interface defines an interface between a P-CSCF and other CSCF.

19. The method according to claim 13, further comprising:
receiving a request for discovering P-CSCF from a network function (NF);
determining at least one P-CSCF matching the request; and
sending a response comprising respective profile of the at least one P-CSCF to the NF, wherein the respective profile of the at least one P-CSCF comprises respective address information of the at least one P-CSCF for respective Mw interface and respective address information of the at least one P-CSCF for respective Gm interface; and/or
wherein the request is Nnrf_NFDiscovery_Request and the response is Nnrf_NFDiscovery_Request Response.

20. (canceled)

21. The method according to claim 19, wherein the NF comprises at least one of:
a service communication proxy (SCP),
a session management function (SMF),
a second NRF,
a policy control function (PCF),
a serving CSCF (S-CSCF), or
a unified data management (UDM).

22-29. (canceled)

30. A method performed by a network function (NF), comprising:
receiving a discovery response message from a network repository function (NRF) indicating a NF profile information of at least one P-CSCF,
wherein the NF profile information of the at least one P-CSCF comprises respective address information of the at least one P-CSCF for respective Mw interface and respective address information of the at least one P-CSCF for respective Gm interface.

31. The method according to claim 30, wherein the discovery response message is an Nnrf_NFDiscovery_Request Response.

32. The method according to claim 30, further comprising: sending a request for discovering proxy call session control function (P-CSCF) to the NRF.

33. The method according to claim 32, wherein the request is an Nnrf_NFDiscovery_Request.

34. The method according to claim 30, further comprising:
sending a subscribe request for subscribing to be notified of a newly registered or updated P-CSCF instance to the NRF; and
receiving a notification about the newly registered or updated P-CSCF instance from the NRF,
wherein the notification comprises a profile or a profile change of the newly registered or updated P-CSCF instance,
wherein the profile or the profile change of the newly registered or updated P-CSCF instance comprises address information of the newly registered or updated P-CSCF instance for Mw interface and/or address information of the newly registered or updated P-CSCF instance for Gm interface.

35. The method according to claim 34, wherein the subscribe request is Nnrf_NFManagement_NFStatusSubscribe Request and the notification is Nnrf_NFManagement_NFStatusNotify.

36. The method according to claim 30, wherein the NF comprises at least one of:
a service communication proxy (SCP),
a session management function (SMF),
a second NRF,
a policy control function (PCF),
a serving CSCF (S-CSCF), or
a unified data management (UDM).

37. The method according to claim 30, wherein address information of a P-CSCF for Mw interface comprises at least one of:
Internet protocol version 4 address of the P-CSCF for the Mw interface,
Internet protocol version 6 address of the P-CSCF for the Mw interface, or
fully qualified domain name of the P-CSCF for the Mw interface.

38. The method according to claim 30, wherein address information of a P-CSCF for Gm interface comprises at least one of:
Internet protocol version 4 address of the P-CSCF for the Gm interface,
Internet protocol version 6 address of the P-CSCF for the Gm interface, or
fully qualified domain name of the P-CSCF for the Gm interface.

39. The method according to claim 30, wherein when the NF is a session management node.

40. The method according to claim 30, wherein the Gm interface defines an interface between a P-CSCF and a user equipment and the Mw interface defines an interface between a P-CSCF and other CSCF.

41-46. (canceled)

47. A network function (NF), comprising:
a processor; and
a memory coupled to the processor, said memory containing instructions executable by said processor, whereby said NF is operative to:
receive a discovery response message from a network repository function (NRF) indicating a NF profile information of at least one P-CSCF,
wherein the NF profile information of the at least one P-CSCF comprises respective address information of the at least one P-CSCF for respective Mw interface and respective address information of the at least one P-CSCF for respective Gm interface.

48-50. (canceled)
